(19) United States
(12) Patent Application Publication
(10) Pub. No.: US 2025/0142128 A1
(43) Pub. Date: May 1, 2025

(54) TECHNIQUES FOR FILM GRAIN MODEL PARAMETERS SIGNALING

(71) Applicant: NETFLIX, INC., Los Gatos, CA (US)

(72) Inventors: Andrey NORKIN, Campbell, CA (US); Li-Heng CHEN, Campbell, CA (US)

(21) Appl. No.: 18/934,050

(22) Filed: Oct. 31, 2024

Related U.S. Application Data
(60) Provisional application No. 63/595,281, filed on Nov. 1, 2023.

(51) Int. Cl. H04N 19/80; H04N 19/91

(52) U.S. Cl. CPC H04N 19/80; H04N 19/91

(57) ABSTRACT

One embodiment of a method for transmitting film grain parameters to one or more client devices for use when playing back video content includes generating, based on one or more film grain parameters associated with video content, one or more compact representations of the one or more film grain parameters associated with the video content, and transmitting the one or more compact representations to a client application executing on a client device, where the client application adds film grain to the video content, for playback, based on the one or more compact representations.

### CROSS-REFERENCE TO RELATED APPLICATIONS

This application claims priority benefit of the United States Provisional Patent Application titled “TECHNIQUES FOR FILM GRAIN MODEL PARAMETER SIGNALING” filed on Nov. 1, 2023, and having Serial No. U.S. 63/595,281. The subject matter of this related application is hereby incorporated herein by reference.

### BACKGROUND

### Field of the Invention

Embodiments of the present disclosure relate generally to media streaming and computer science, more specifically, to techniques for film grain model parameter signaling.

### Description of the Related Art

Film grain is a random optical effect originally attributable to the presence of small particles of metallic silver or dye clouds found on processed photographic film. During playback of video content that includes film grain, the film grain appears as imperfections that provide a distinctive “movie” look to the video content that is aesthetically valued by many producers and viewers. By contrast, during playback of video content that does not include film grain, the lack of those film grain “imperfections” can make the video content appear artificial.

One approach for providing the aesthetically pleasing movie look that includes film grain is to model the film grain and then apply the modeled film grain to the video content prior to playback. The modeling can use a number of parameters, referred to herein as “film grain parameters,” that define various properties of the film grain. The film grain parameters can then be transmitted, along with encoded video content, to one or more client devices. In addition, when the video content is encoded at multiple resolutions that the client devices can select for playback, different film grain parameters can be transmitted for each of those resolutions. Each client device can implement a reconstruction application that synthesizes the film grain for a display resolution based on the film grain parameters associated with that resolution. The reconstruction application combines the synthesized film grain with decoded video content that is scaled to the display resolution to generate reconstructed video content that can be played back via a display device.

One drawback of the above approach is that the transmission of film grain parameters, each of which is at least one hundred bytes in size, can consume significant amounts of network bandwidth and cause delays in the playback of video content. Alternatively, the above approach for transmitting film grain parameters can decrease the playback quality due to the reconstruction application having to choose a lower quality/lower bitrate rendition of the video content. These problems are exacerbated when different film grain parameters need to be transmitted for multiple resolutions at which video content is encoded, as well as when different film grain parameters need to be transmitted for film grain that changes across different scenes within the video content.

As the foregoing illustrates, what is needed in the art are more effective techniques for applying modeled film grain to video content.

### SUMMARY OF THE EMBODIMENTS

One embodiment of the present disclosure sets forth a computer-implemented method for transmitting film grain parameters to one or more client devices for use when playing back video content. The method includes generating, based on one or more film grain parameters associated with video content, one or more compact representations of the one or more film grain parameters associated with the video content. The method further includes transmitting the one or more compact representations to a client application executing on a client device, where the client application adds film grain to the video content, for playback, based on the one or more compact representations.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that, with the disclosed techniques, fewer bits corresponding to film grain parameters need to be transmitted to client devices during streaming sessions. The transmission of fewer bits corresponding to film grain parameters can reduce the amount of network bandwidth consumed when streaming video content, reduce delays in the playback of the video content, and/or increase the playback quality relative to prior art approaches. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a system configured to implement one or more aspects of the various embodiments;

FIG. 2 is a more detailed illustration of the server of FIG. 1, according to the various embodiments;

FIG. 3 is a more detailed illustration of one of the computing devices of FIG. 1, according to the various embodiments;

FIG. 4 is a more detailed illustration of the encoder and the client application of FIG. 1, according to various embodiments;

FIG. 5 illustrates how template parameters can be signaled, according to various embodiments;

FIG. 6 illustrates how compact representations of scaling functions can be generated, according to various embodiments;

FIG. 7 is a flow diagram of method steps for transmitting compact representations of film grain parameters, according to various embodiments;

FIG. 8 is a flow diagram of method steps for generating one or more compact representations of template parameters, according to various embodiments;

FIG. 9 is a flow diagram of method steps for generating one or more compact representations of scaling parameters, according to various embodiments; and

FIG. 10 is a flow diagram of method steps for generating reconstructed video content using transmitted film grain parameters, according to various embodiments.

### DETAILED DESCRIPTION

As described, conventional approaches for transmitting film grain parameters, each of which is at least one hundred bytes in size, can consume significant amounts of network bandwidth, cause delays in the playback of video content, and/or decrease the playback quality due to a reconstruction application having to choose a lower quality/lower bitrate rendition of the video content. These problems are exacerbated when different film grain parameters need to be transmitted for multiple resolutions at which video content is encoded, as well as when different film grain parameters need to be transmitted for film grain that changes across different scenes of the video content.

The disclosed techniques transmit compact representations of film grain parameters. In some embodiments, the film grain parameters include parameters that define a set of scaling functions that indicate how the luma and chroma values of film grain are scaled for different resolutions of video content. In such cases, compact representations of the parameters that define the set of scaling functions can be generated by using a least square linear regression technique to compute the coefficients of linear functions so that one of the scaling functions can be used to obtain predictions of the other scaling functions, for example, through linear prediction of type f2(x)=a*f1(x)+b. In some embodiments, the compact representations further include residuals (i.e., the differences) between the predictions of the other scaling functions and the actual other scaling functions. The residuals can be encoded using lossy encoding in some embodiments. In addition or alternatively, in some embodiments, compact representations of the parameters that define the set of scaling functions can be generated to include increments between x-coordinate values in the parameters that define each scaling function. In such cases, the increments can also be represented as a set of differences from an offset. In addition, the increments can be represented using fewer bits when the maximum possible size of the increments decreases. In some embodiments, y-coordinate values in the parameters that define one or more scaling functions can also be represented as differences from an offset, such as by selecting an offset and encoding y values as a+bi, where a is constant, and bi varies for each sample.

In some embodiments, the film grain parameters include coefficients of an autoregressive model for computing a film grain template, portions of which can be applied as film grain to video content. In such cases, compact representations of the coefficients of the autoregressive model can use a limited number of bits to represent each coefficient. The limited number of bits can be determined as the number of bits required to represent values within a range of the coefficients of the autoregressive model.

An encoder can generate compact representations of film grain parameters using any combination of the foregoing techniques. The encoder can transmit the compact representations of film grain parameters, as well as encoded video content, to client applications. In particular, the compact representations of film grain parameters can be transmitted in a bitstream. In addition, the encoder can transmit metadata specifying bits in the bitstream corresponding to the compact representations of film grain parameters. Using such metadata, the client applications can read the compact representations of film grain parameters from the bitstream, determine the film grain parameters from the compact representations, synthesize film grain based on the film grain parameters, and generate reconstructed video content for output that includes decoded video content as well as the synthesized film grain.

Advantageously, with the disclosed techniques, fewer bits corresponding to film grain parameters need to be transmitted to client devices during streaming sessions. The transmission of fewer bits corresponding to film grain parameters can reduce the amount of network bandwidth consumed when streaming video content, reduce delays in the playback of the video content, and/or increase the playback quality relative to prior art approaches.

### System Overview

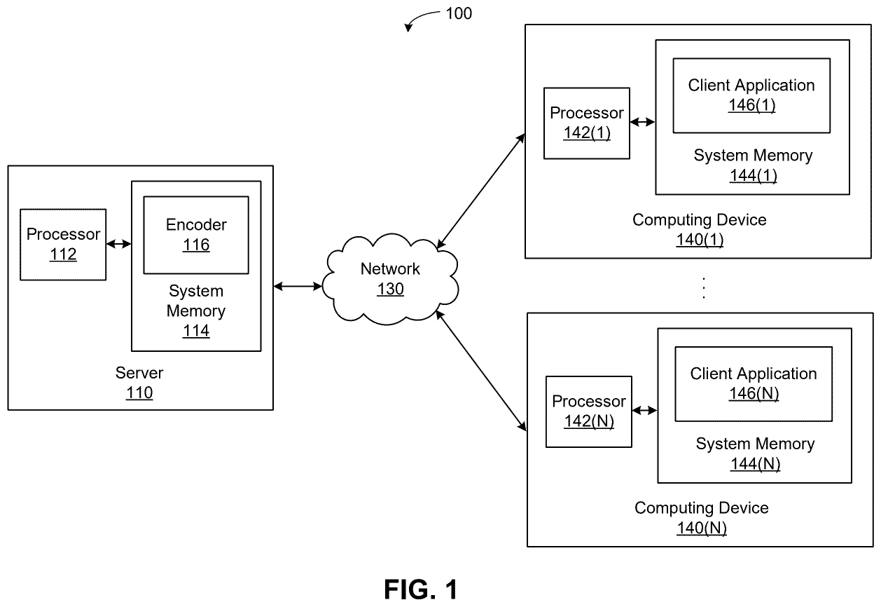

FIG. 1 illustrates a system 100 configured to implement one or more aspects of the various embodiments. As shown, the system 100 includes a server 110 in communication with a number of computing devices 140(1)-(N) (referred to herein collectively as computing devices 140 and individually as a computing device 140) over a network 130. The network 130 may be a wide area network (WAN) such as the Internet, a local area network (LAN), a wireless network, or any other suitable network.

As shown, an encoder 116 executes on a processor 112 of the server 110 and is stored in a system memory 114 of the server 110. In operation, the processor 112 is the master processor of the server 110, controlling and coordinating operations of other system components. The memory 114 of the server 110 stores content, such as software applications and data, for use by the processor 112. The memory 114 may be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) may supplement or replace the memory 114. The storage may include any number and type of external memories that are accessible to the processor 112, such as a Secure Digital Card, an external Flash memory, a portable compact disc read-only memory (CD-ROM), an optical storage device, a magnetic storage device, or any suitable combination of the foregoing.

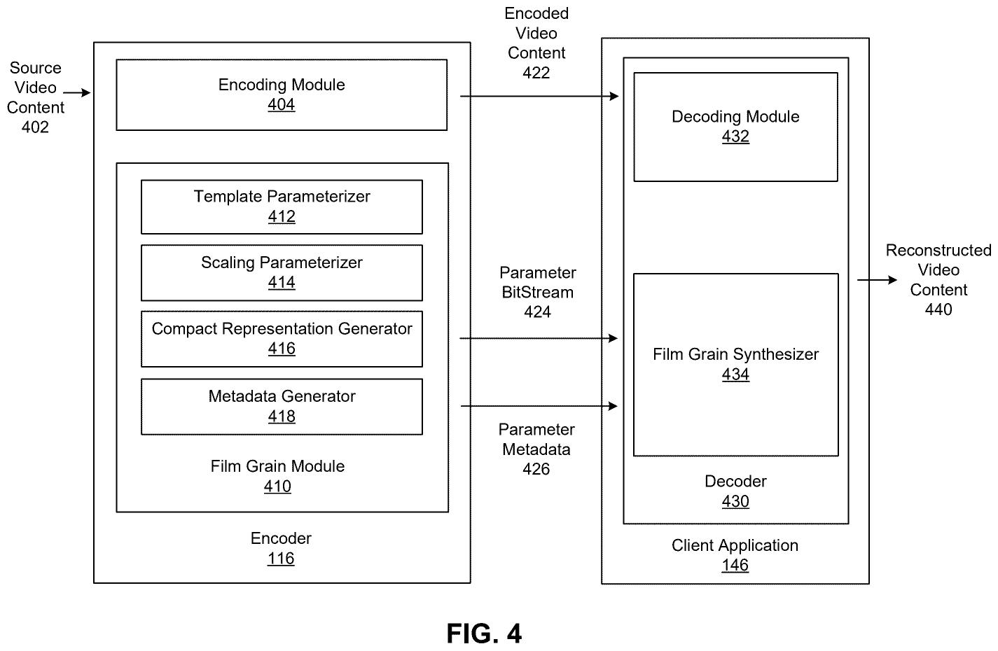

The encoder 116 is specialized software and/or hardware designed to convert digital content into a suitable format for storage, transmission, and/or display. The encoder 116 can process various types of content, such as audio and/or video, by applying compression algorithms and encoding schemes to transform raw data content into one or more optimized, standardized formats. In some embodiments, the encoder 116 can also generate compact representations of one or more film grain parameters, which can then be transmitted to one or more client applications 146(1)-(N) (referred to herein collectively as client application 146 and individually as a client application 146) executing on the computing devices 146(1)-(N), respectively, and used therein to synthesize film grain for video content, as discussed in greater detail below in conjunction with FIGS. 4-10.

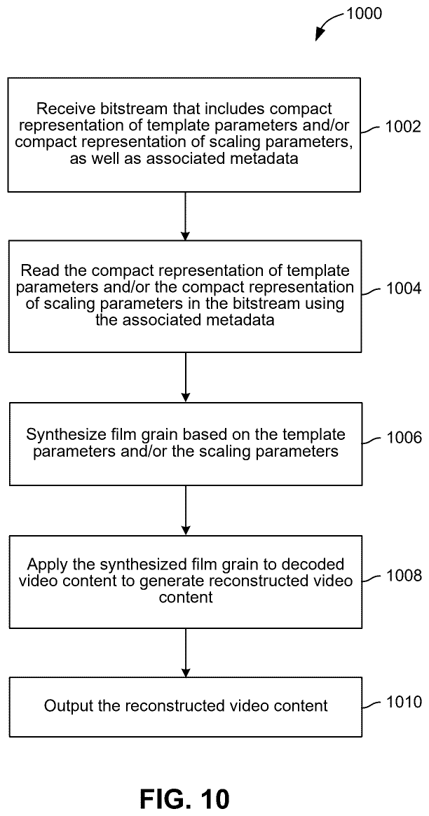

Illustratively, client applications 146(1)-(N) are stored in memories 144(1)-(N) (referred to herein collectively as memories 144 and individually as a memory 144), and executes on processors 142(1)-(N) (referred to herein collectively as processors 142 and individually as a processor 142), of the computing devices 146(1)-(N), respectively. Client applications 146 are configured to decode video content received from encoder 116, synthesize film grain based on compact representations of film grain parameters, generate reconstructed video content that includes the decoded video content and the synthesized film grain, and cause the reconstructed video content to be output via a display device, as discussed in greater detail below in conjunction with FIGS. 4 and 10. In some embodiments, components of the computing device 140, including the memory 144 and the processor 142, can be similar to corresponding components of the server 110.

The number of machine learning servers and application servers may be modified as desired in some embodiments. Further, the functionality included in any of the applications may be divided across any number of applications or other software that are stored and executed via any number of devices that are located in any number of physical locations.

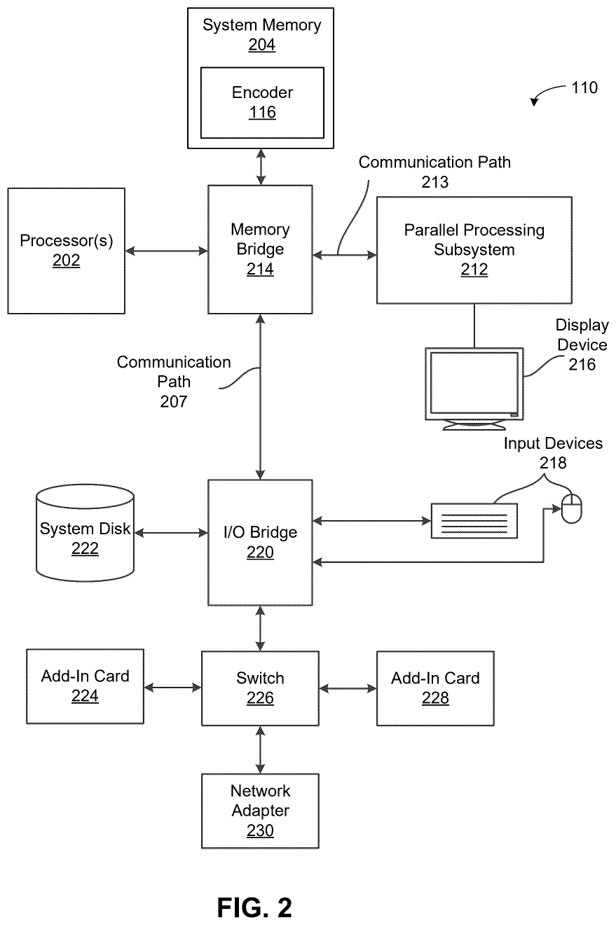

FIG. 2 is a more detailed illustration of the server 110 of FIG. 1, according to the various embodiments. The server 110 may be any type of computing device, including, without limitation, a server machine, a server platform, a desktop machine, a laptop machine, a hand-held/mobile device, a digital kiosk, an in-vehicle infotainment system, and/or a wearable device. In some embodiments, the server 110 is a server machine operating in a data center or a cloud computing environment that provides scalable computing resources as a service over a network.

As shown, the server 110 includes, without limitation, processor(s) 202 and system memory (ies) 204 coupled to a parallel processing subsystem 212 via a memory bridge 214 and a communication path 213. The memory bridge 214 is further coupled to an I/O (input/output) bridge 220 via a communication path 207, and the I/O bridge 220 is, in turn, coupled to a switch 226.

In various embodiments, the I/O bridge 220 is configured to receive user input information from optional input devices 218, such as a keyboard, mouse, touch screen, sensor data analysis (e.g., evaluating gestures, speech, or other information about one or more uses in a field of view or sensory field of one or more sensors), and/or the like, and forward the input information to the processor(s) 202 for processing. In some embodiments, the server 110 may be a server machine in a cloud computing environment. In such embodiments, the server 110 may not include the input devices 218, but may receive equivalent input information by receiving commands (e.g., responsive to one or more inputs from a remote computing device) in the form of messages transmitted over a network and received via the network adapter 230. In some embodiments, the switch 226 is configured to provide connections between the I/O bridge 220 and other components of the server 110, such as a network adapter 230 and various add-in cards 224 and 228.

In some embodiments, the I/O bridge 220 is coupled to a system disk 222 that may be configured to store content and applications and data for use by the processor(s) 202 and the parallel processing subsystem 212. In one some embodiments, the system disk 222 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 220 as well.

In various embodiments, the memory bridge 214 may be a Northbridge chip, and the I/O bridge 220 may be a Southbridge chip. In addition, communication paths 207 and 213, as well as other communication paths within the server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 216 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The memory 204 includes at least one device driver configured to manage the processing operations of the one or more PPUs within the parallel processing subsystem 212. Illustratively, the memory 204 includes, without limitation, the encoder 116.

In various embodiments, the parallel processing subsystem 212 may be integrated with one or more of the other elements of FIG. 2 to form a single system. For example, the parallel processing subsystem 212 may be integrated with the processor(s) 202 and other connection circuitry on a single chip to form a system on a chip (SoC).

In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, the system memory 204 could be connected to the processor(s) 202 directly rather than through the memory bridge 214, and other devices may communicate with the system memory 204 via the memory bridge 214 and the processor(s) 202. In other embodiments, the parallel processing subsystem 212 may be connected to the I/O bridge 220 or directly to the processor(s) 202, rather than to memory bridge 214. In still other embodiments, the I/O bridge 220 and the memory bridge 214 may be integrated into a single chip instead of existing as one or more discrete devices. In certain embodiments, one or more components shown in FIG. 2 may not be present. For example, the switch 226 could be eliminated, and the network adapter 230 and the add-in cards 224, 228 would connect directly to the I/O bridge 220. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

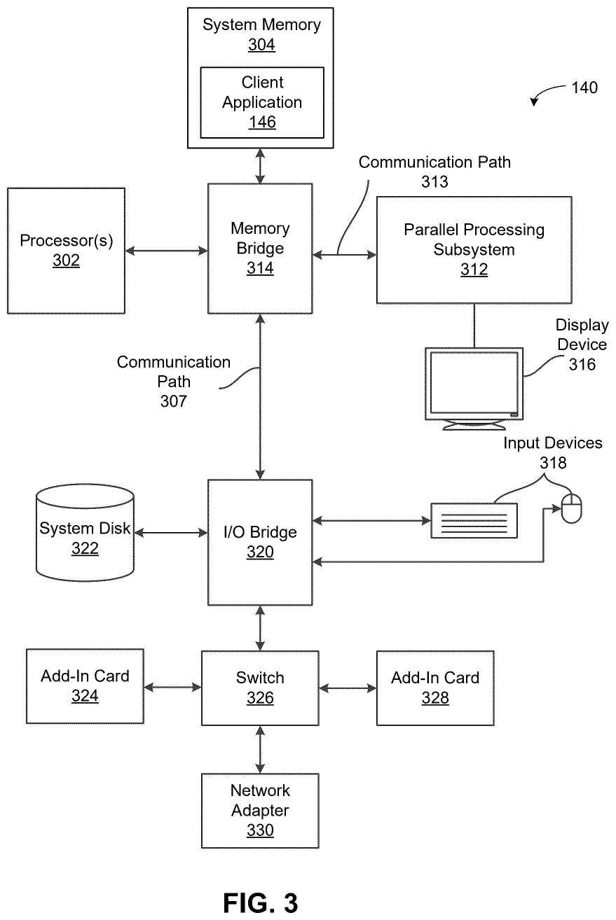

FIG. 3 is a more detailed illustration of one of the computing devices 140 of FIG. 1, according to the various embodiments. The computing device 140 may be any type of computing device, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network.

As shown, the computing device 140 includes, without limitation, processor(s) 302 and system memory (ies) 304 coupled to a parallel processing subsystem 312 via a memory bridge 314 and a communication path 313. The memory bridge 314 is further coupled to an I/O (input/output) bridge 320 via a communication path 307, and the I/O bridge 320 is, in turn, coupled to a switch 326.

In various embodiments, the I/O bridge 320 is configured to receive user input information from optional input devices 318, such as a keyboard, mouse, touch screen, sensor data analysis (e.g., evaluating gestures, speech, or other information about one or more uses in a field of view or sensory field of one or more sensors), and/or the like, and forward the input information to the processor(s) 302 for processing. In some embodiments, the computing device 140 may be a server machine in a cloud computing environment. In such embodiments, the computing device 140 may not include the input devices 318, but may receive equivalent input information by receiving commands (e.g., responsive to one or more inputs from a remote computing device) in the form of messages transmitted over a network and received via the network adapter 330. In some embodiments, the switch 326 is configured to provide connections between the I/O bridge 320 and other components of the computing device 140, such as a network adapter 330 and various add-in cards 324 and 328.

In some embodiments, the I/O bridge 320 is coupled to a system disk 322 that may be configured to store content and applications and data for use by the processor(s) 302 and the parallel processing subsystem 312. In one some embodiments, the system disk 322 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 320 as well.

In various embodiments, the memory bridge 314 may be a Northbridge chip, and the I/O bridge 320 may be a Southbridge chip. In addition, communication paths 307 and 313, as well as other communication paths within the computing device 140, may be implemented using any technically suitable protocols, including, without limitation, AGP (Accelerated Graphics Port), HyperTransport, or any other bus or point-to-point communication protocol known in the art.

In some embodiments, the parallel processing subsystem 312 comprises a graphics subsystem that delivers pixels to an optional display device 316 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The memory 304 includes at least one device driver configured to manage the processing operations of the one or more PPUs within the parallel processing subsystem 312. Illustratively, the memory 304 includes, without limitation, a client application 146.

In various embodiments, the parallel processing subsystem 312 may be integrated with one or more of the other elements of FIG. 3 to form a single system. For example, the parallel processing subsystem 312 may be integrated with the processor(s) 302 and other connection circuitry on a single chip to form a system on a chip (SoC).

In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 302, and the number of parallel processing subsystems 312, may be modified as desired. For example, in some embodiments, the system memory 304 could be connected to the processor(s) 302 directly rather than through the memory bridge 314, and other devices may communicate with the system memory 304 via the memory bridge 314 and the processor(s) 302. In other embodiments, the parallel processing subsystem 312 may be connected to the I/O bridge 320 or directly to the processor(s) 302, rather than to memory bridge 314. In still other embodiments, the I/O bridge 320 and the memory bridge 314 may be integrated into a single chip instead of existing as one or more discrete devices. In certain embodiments, one or more components shown in FIG. 3 may not be present. For example, the switch 326 could be eliminated, and the network adapter 330 and the add-in cards 324, 328 would connect directly to the I/O bridge 320. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Signaling Film Grain Parameters

FIG. 4 is a more detailed illustration of the encoder 116 and the client application 146, according to various embodiments. As shown, the encoder 116 includes an encoding module 404 and a film grain module 410. In operation, the encoder 116 can generate compact representations of film grain parameters using any combination of the techniques disclosed herein. The encoder 116 transmits the compact representations of film grain parameters in a parameter bitstream 424 to client application, shown as client application 146. The encoder 116 also transmits, to the client application 146, parameter metadata 426 specifying bits in the parameter bitstream 424 that correspond to the compact representations of film grain parameters. In addition, the encoder 116 transmits to the client application 146 encoded video content 422, which the encoding module 404 can encode from source video content 402 using any technically feasible compression algorithm(s) and encoding scheme(s) to transform raw video content into one or more optimized, standardized formats. Any suitable source video 402, such as live-streamed video content that is encoded in real-time or video-on-demand (VOD) video content that is pre-encoded, can be encoded in some embodiments. Using the parameter metadata 426, the client application 146 can read the compact representations of film grain parameters from the parameter bitstream 424, determine the film grain parameters from the compact representations, synthesize film grain based on the film grain parameters, and generate reconstructed video content 440 for output that includes decoded video content as well as the synthesized film grain, as discussed in greater detail below. In some embodiments, the encoding process can also include denoising and downscaling source video content. In such cases, the decoding process can also include upscaling decoded video content to display resolution before film grain is applied.

In some embodiments, the film grain parameters include coefficients of an autoregressive model, which are also referred to herein as “template parameters,” for computing a film grain template. The template parameters are computed by a template parameterizer 412 of the film grain module. In some embodiments, the template parameters can be computed according to the techniques disclosed in U.S. Pat. No. 10,839,489, which is incorporated by reference herein in its entirety. Given the template parameters, the decoder 430 can compute the film grain template and apply portions thereof as film grain to decoded video content, output by a decoding module 432, in order to generate the reconstructed video content 440. Although described herein primarily with respect to the decoder 430 adding film grain to video content, in some embodiments, another module or another application, such as an application running in a cloud computing environment, can add film grain and perform functionalit(ies) of the decoder 430 that are described herein. In some embodiments, the coefficients of the autoregressive model can be represented using a compact representation that uses a limited number of bits to represent each coefficient. In some embodiments, a compact representation generator 416 of the film grain module 410 can determine the limited number of bits to use by identifying a largest coefficient and a smallest coefficient of the autoregressive model, forming a range of coefficients from the largest coefficient to the smallest coefficient, and determining the number of bits required to represent the values within the range of the coefficients. For example, experience has shown that such coefficients can oftentimes be represented using only 4-8 bits. As another example, if the range of coefficients indicates that the maximum coefficient value is less than 128, then at most 7 bits would be required to represent the coefficient values. The compact representation generator 416 can then encode the coefficients of the autoregressive model using the limited number of bits and add the encoded coefficients to the parameter bitstream 424. In addition, a metadata generator 418 of the film grain module 410 can generate the parameter metadata 426 to indicate the limited number of bits used to represent the coefficients of the autoregressive model. The limited number of bits can be indicated in any technically feasible manner, including as a difference that is to be added to an offset. For example, 7 bits could be indicated as 2 bits that the decoder 430 adds to an offset of 5, which can also be specified in the metadata, to obtain the 7 bits. Given such metadata, the client application 146 can loop through the number of autoregressive coefficients and read the number of bits specified in the metadata for each coefficient. In addition, new metadata can be transmitted each time the film grain changes in the video content, such as every frame or a range of frames.

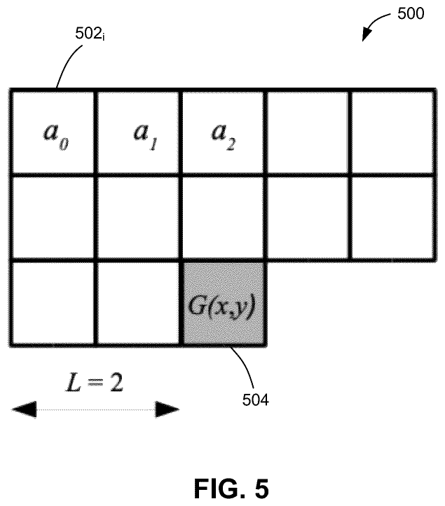

FIG. 5 illustrates how template parameters can be signaled, according to various embodiments. Shown is a sample 500 of film grain G (x, y) 504 with autoregressive coefficients 502i (referred to herein collectively as autoregressive coefficients 502 and individually as an autoregressive coefficient 502) in the luma component. The autoregressive model for representing the film grain pattern can be used to synthesize the template of the film grain as follows. Let G (x, y) be a zero-mean film grain sample at the position with coordinates (x, y). For the parameters lag L=2, the grain sample G can be calculated as:

$$G ( x , y ) = a 0 G ( x - 2 , y - 2 ) + a 1 G ( x - 1 , y - 2 ) + a 2 G ( x , y - 2 ) + … + z . \qquad ( 1 )$$

In some embodiments, lags of size 0 to 3 are supported. The foregoing description applies to modeling of the grain for the luma component. Since film grain in YCbCr video components may be correlated, the autoregressive models for chroma components have an additional autoregressive coefficient to capture the correlation between the chroma component grain and a collocated luma sample grain.

In some embodiments, to signal the autoregressive coefficients 502 to client applications, the compact representation generator 416 can determine a limited number of bits to use by identifying a largest coefficient and a smallest coefficient of the autoregressive coefficients 502, forming a range of coefficients from the largest coefficient to the smallest coefficient. Then, the compact representation generator 416 can determine a number of bits required to represent the values within the range of the autoregressive coefficients 502. Thereafter, the compact representation generator 416 can then encode the autoregressive coefficients 502 and transmit the encoded coefficients in bitstreams (e.g., parameter bitstream 424) to client applications, as described above in conjunction with FIG. 4. In some embodiments, the autoregressive coefficients 502 can also be encoded in any technically feasible manner, including using variable-length encoding, such as exp-Golomb codes.

Returning to FIG. 4, in some embodiments, the film grain parameters can also include parameters that define a set of scaling functions that indicate how the film grain, which can be synthesized using the autoregressive model described above, is scaled for different luma and/or chroma values and resolutions of video content. That is, before film grain is applied to video content, the strength of the film grain is scaled based on the underlying pixel values using a scaling function for the resolution of the video content. The input (x-coordinate value) to the scaling function is a luma or chroma value, and the output (y-coordinate value) of the scaling function is a scaling to apply to film grain when the film grain added to video content. More formally, because film grain strength varies between different areas of a picture and the film grain typically depends on the intensity of the signal, the luma film grain can be modeled as a function of the signal intensity, such that when adding film grain to the Y component, the following model can be used:

$${Y}^{′} = Y + f ( Y ) GL , \qquad ( 2 )$$

where Y′ is the luma re-noised with film grain, Y is the reconstructed value of luma (before adding film grain), and GL is the luma film grain sample. In equation (2), f(Y) is a function that scales the film grain based on the value of the luma. f(Y) is represented with the piecewise-linear function that can be implemented as a pre-computed look-up table (LUT). For all bit depths, LUT can take 256 values, and for bit-depths higher than 8, the values between the LUT entries can be obtained with linear interpolation. For example, up to 14 f(Y) pairs can be signaled to represent the scaling function for the Y component. For a chroma component (e.g., Cb), the film grain can be scaled using the following equations:

$${Cb}^{′} = C b + f ( u ) GCb , \qquad ( 3 )$$

$$u = bCb Cb + dCb Yav + h , \qquad ( 4 )$$

where u is the index corresponding to a Cb component scaling function. The index depends on both the Cb and luma components for the pixel. Yav is the average luma corresponding to the chroma sample, taken from one line of samples. For 4:2:0 YCbCr format, Yav=(Y1+Y2+1)>>1, where Y1, Y2 are neighboring (co-located) luma samples located on the even line (numbering starts from 0).

Parameters of the scaling functions, which are also referred to herein as “scaling parameters,” are determined by a scaling parameterizer 414 of the film grain module 410. In some embodiments, the scaling functions can be piecewise linear functions, and the scaling parameters can define points at the ends of linear segments of the piecewise linear functions. In some embodiments, the scaling functions and parameters thereof can be determined according to the techniques disclosed in U.S. Pat. No. 10,839,489.

In some embodiments, the compact representation generator 416 can generate compact representations of the scaling parameters that can be used to predict other scaling functions from one of the scaling functions that is used as a basis, from which the other scaling functions are computed. Although described herein primarily with one scaling function being used as the basis as a reference example, in some embodiments, multiple scaling functions can be signaled explicitly, from which other scaling functions can be predicted. Compact representations that represent at least linear functions for predicting other scaling functions from one scaling function can be computed for a luma component and two chroma components so that the other scaling functions that are predicted can be used to scale the luma and chroma component film grain that are generated. In some embodiments, the compact representation generator 416 can perform a least square linear regression technique to compute the coefficients a and b of linear functions fi(Y)=a*fj(Y)+b that can be used to obtain predictions of the other scaling functions for other resolutions from one of the scaling functions for one resolution. For example, assume that the piecewise linear scaling function for luma is modeled using up to 14 pairs of Y and f(Y) values. Suppose that the scaling function for resolution 1 is coded by sending the 14 pairs of Y and f(Y) values, where Y correspond to the luma or index values and f1(Y) to luma intensity. In such a case, the values for the scaling function for resolution 2 can be computed as Y and f2(Y)=a*f1(Y)+b. The same terms a and b can be applied to a plurality of f(Y) points. Although described herein primarily with respect to linear functions as a reference example, in some embodiments, any technically feasible functions can be used, such as a quadratic function or just a multiplier for each resolution whose scaling function is to be predicted.

Accordingly, only the scaling parameters for the one of the scaling functions needs to be transmitted to client applications, along with the coefficients of the linear functions (or other functions) for predicting the other scaling functions, which can require less bits to transmit than the parameters of all of the scaling functions. In some embodiments, the compact representation generator 416 can further generate the compact representations of the scaling parameters to include residuals (i.e., the differences) between the predictions of the other scaling functions and the actual other scaling functions. The residuals can be computed as differences between the predicted values of fi(Y) and the actual values of fj(Y). In addition, the residuals can be encoded using lossy encoding in some embodiments, such as signaling residuals with a coarser granularity than 1, for example in multiples of 2, 3, 4, etc., or encoded in any other technically feasible manner, such as using fixed length encoding of residual values while choosing fewer bits to signal a difference from an offset, via exp-Golomb codes, by only sending the values from another scaling function and only sending corresponding scaling values, or the like. Using the residuals, the client applications can (1) predict other scaling functions using the linear functions and one scaling function that is the basis, and (2) add the residuals associated with the other scaling functions to obtain more accurate predictions for the other scaling functions.

In addition or alternatively, in some embodiments, the compact representation generator 416 can generate compact representations of scaling parameters that include increments between x-coordinate values in the parameters that define one or more scaling functions, such as one scaling function that is used, along with linear functions, to predict other scaling functions as described above. The x-coordinate value represents luma and/or chroma, and the y-coordinate value represents a scaling granularity multiplier for computing a strength of film grain that should be applied for pixels having the x-coordinate values. It should be understood that the increments can have smaller values, and can be represented using fewer bits, than x-coordinate values themselves. In some embodiments, the increments can also be represented as a set of differences from an offset, which can require even fewer bits than representing the increments themselves. In some embodiments, the increments can also be represented using fewer bits in the compact representations when the maximum possible size of the increments decrease, because the decreasing increment sizes have smaller values that do not require as many bits to represent in the compact representations. In some other embodiments, the number of bits used to encode the parameters of scaling functions can be limited in any technically feasible manner. For example, in some embodiments, variable-length encoding, such as exp-Golomb codes, can be used to encode the parameters of scaling functions. In some embodiments, y-coordinate values in the parameters that define the one or more scaling functions can also be represented as differences from an offset, such as by selecting an offset and encoding y values as a+bi, where a is constant, and bi varies for each sample. In such cases, a prediction of a y-coordinate value can be based on the offset that is a common base rather than a previous sample value.

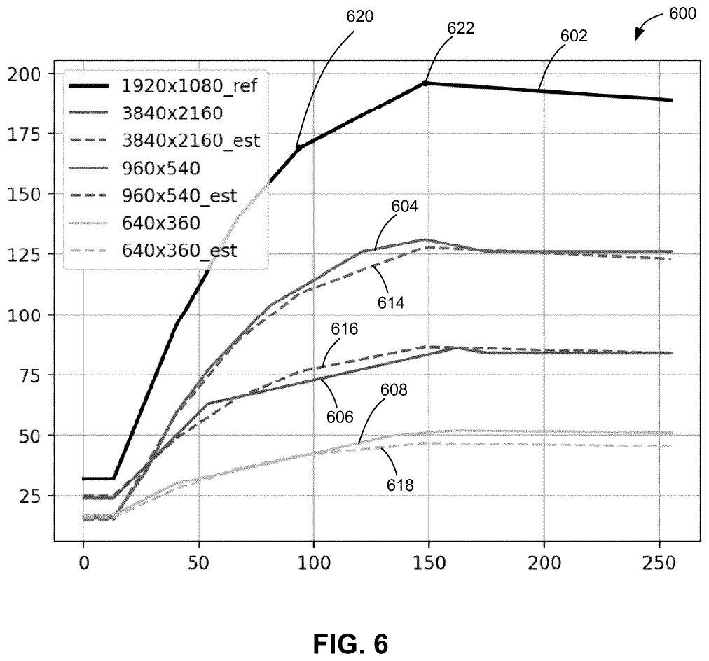

FIG. 6 illustrates how compact representations of scaling functions can be generated, according to various embodiments. As shown, values of a scaling function 602 for one resolution can be input as fj(Y) into linear functions of the form fi(Y)=a*fj(Y)+b to obtain predictions of values of scaling functions for other resolutions 614, 616, and 618. This is because the scaling functions at different resolutions are often similar to each other, which can be due to the fact that the film grain strength varies in a similar way between different areas of the picture/frame. In this case, the relationship between the grain intensity will likely stay the same for different resolutions, even though the intensity values themselves can be quite different. The difference between intensity/strength of the film grain at different resolutions are related to the fact the film grain and other noise, such as sensor noise, is low-pass filtered during downscaling of an image or video sequence, described above.

In some embodiments, the compact representation generator 416 can determine the linear functions via a least square linear regression technique and include coefficients a and b of the linear functions in a parameter bitstream (e.g., parameter bitstream 424), as described above in conjunction with FIG. 4. In some embodiments, the compact representation generator 416 can further generate the compact representations to include residuals between the predictions of the other scaling functions 614, 616, and 618 and the actual other scaling functions 604, 616, and 618, respectively. In such cases, the residuals can include the differences between the predictions of the other scaling functions 614, 616, and 618 and the actual other scaling functions 604, 616, and 618, respectively at one or more points. Further, in some embodiments, the residuals can be encoded to any suitable degree of precision using lossy encoding, or in any other technically feasible manner, in order to limit the number of bits that are transmitted for each residual.

In addition or alternatively, in some embodiments, the compact representation generator 416 can generate compact representations of the parameters defining scaling functions to include increments between x-coordinate values in the parameters that define one or more scaling functions. Illustratively, the parameters that define the scaling function 602 can include the (x,y) coordinates of points (e.g., points 620 and 622) at the ends of linear segments of the scaling function 602. Because the x coordinates of such points increase monotonically, the value of each x-coordinate value can be represented an increment from a previous x-coordinate value (including an increment of 0 for a first x-coordinate value), which can require less bits than is required to represent the actual value of the x-coordinate. For example, 8 bits are required to represent an x-coordinate luma or chroma value between 0 and 255. However, after the x-coordinate value exceeds 128, the maximum increment is less than 128, meaning the increment can be represented using 7 bits or less. Similarly, when the maximum increment is less than 64, then 6 bits or less are needed to represent the increment, and so forth. Accordingly, the difference between the current x-coordinate value and the end of the x-coordinate interval (e.g., 255) can be used to compute the maximum number of bits required to represent the increment. In some embodiments, the increments can also be encoded in any technically feasible manner, such as using exp-Golomb codes.

Further, in some embodiments, the increments can also be represented as a set of differences from an offset, which can require fewer bits than representing the increments themselves. For example, each of the increments for the points of the scaling function 602 is roughly equal in size. Accordingly, the increments can be represented as slight differences from a common offset size. In some embodiments, the differences from the offset can also be encoded in any technically feasible manner, such as using exp-Golomb codes. In some embodiments, y-coordinate values in the parameters that define one or more scaling functions can also be represented as differences from an offset, such as by selecting an offset and encoding y values as a+bi, where a is constant, and bi varies for each sample. As described, in such cases, a prediction of a y-coordinate value can be based on the offset that is a common base rather than a previous sample value.

Additionally, in some embodiments, the increments of the x-coordinate values (and/or the y-value differences) can also be represented using fewer bits in the compact representations when the maximum possible size of the increments decrease, because the decreasing increment sizes have smaller values that do not require as many bits to represent in the compact representations. Illustratively, the x-coordinate of the point 622 is greater than 128, and the maximum possible value of the x-coordinate is 255. In such a case, the increment used to represent the x-coordinate of the point 622 can be no larger than 128. Accordingly, the increment can be represented using enough bits (7 bits) for a value that is smaller than 128, rather than enough bits to represent a value up to 255.

The compact representation generator 416 can generate compact representations of the scaling parameters that can be used to predict other scaling functions at other resolutions from one of the scaling functions at one resolution that is used as a basis. In such cases, the compact representation generator 416 can perform a least square linear regression technique to compute the coefficients a and b of linear functions fi(Y)=a*fj(Y)+b that can be used to obtain predictions of other scaling functions from one of the scaling functions.

Exemplar syntax for compact representations of scaling parameters that can be used to predict the scaling functions for different resolutions from the scaling function at one of the resolutions that is used as a basis is shown below in Table 1.

TABLE 1

| | *Type* |
|---|---|
| av1_film_grain_params( ) | |
| predict_scaling | f(1) |
| if (predict_scaling) | |
| film_grain_param_set_idx_for_prediction | f(3) |
| if (predict_scaling) { | |
| predict_luma_scaling | f(1) |
| if (predict_luma_scaling) { | |
| luma_scaling_mult | f(9) |
| luma_scaling_add | f(9) |
| } else { | |
| num_y_points f(4) | |
| for ( i = 0; i < num_y_points; i++ ) { | |
| point_y_value[ i ] | f(8) |
| point_y_scaling[ i ] | f(8) |
| } | |
| } | |
| luma_only_grain | f(1) |
| if ( luma_only_grain ) { | |
| chroma_scaling_from_luma = 0 | |
| } else { | |
| chroma_scaling_from_luma | f(1) |
| } | |
| if ( luma_only_grain \|\| chroma_scaling_from_luma ) { | |
| num_cb_points = 0 | |
| num_cr_points = 0 | |
| } else { | |
| if (predict_scaling) { | |
| predict_cb_scaling | f(1) |
| if (predict_cb_scaling) { | |
| cb_scaling_mult | f(9) |
| cb_scaling_add | f(9) |
| num_cb_points = 0 | |
| } else { | |
| num_cb_points | f(4) |
| for ( i = 0; i < num_cb_points; i++ ) { | |
| point_cb_value[ i ] | f(8) |
| point_cb_scaling[ i ] | f(8) |
| } | |
| } | |
| if (predict_scaling) { | |
| predict_cr_scaling f(1) | |
| if (predict_cr_scaling) { | |
| cr_scaling_mult | f(9) |
| cr_scaling_add | f(9) |
| num_cr_points = 0 | |
| } else { | |
| num_cr_points | f(4) |
| for ( i = 0; i < num_cr_points; i++ ) { | |
| point_cr_value[ i ] | f(8) |
| point_cr_scaling[ i ] | f(8) |
| } | |
| } | |
| } | |
| grain_scaling_minus_8 | f(2) |
| ar_coeff_lag | f(2) |
| numPosLuma = 2 * ar_coeff_lag * ( ar_coeff_lag + 1 ) | |
| if ( num_y_points \|\| predict_luma_scaling ) { | |
| numPosChroma = numPosLuma + 1 | |
| for ( i = 0; i < numPosLuma; i++ ) | |
| ar_coeffs_y_plus_128[ i ] | f(8) |
| } else { | |
| numPosChroma = numPosLuma | |
| } | |
| if ( chroma_scaling_from_luma \|\| num_cb_points \|\| | |
| predict_cb_scaling ) { | |
| for ( i = 0; i < numPosChroma; i++ ) | |
| ar_coeffs_cb_plus_128[ i ] | f(8) |
| } | |
| if ( chroma_scaling_from_luma \|\| num_cr_points \|\| | |
| predict_cr_scaling) { | |
| for ( i = 0; i < numPosChroma; i++ ) | |
| ar_coeffs_cr_plus_128[ i ] | f(8) |
| } | |

In Table 1, predict_scaling equal to 0 specifies that scaling functions in the current film grain parameter set are not predicted from scaling functions that belong to other film grain parameters sets. predict_scaling equal to 1 specifies that scaling functions in the current film grain parameter set may be predicted from scaling functions that belong to other film grain parameters sets.

film_grain_param_set_idx_for_prediction specifies an index of a film grain parameter set that is used for prediction of scaling functions of the current film grain parameter set. In some embodiments, the values of the film grain parameter set with index film_grain_param_set_idx_for prediction are required to be initialized with values of the scaling functions that are in the current coded video sequence.

predict_luma_scaling equal to 0 indicates that the luma scaling functions in the current film grain parameter set are not predicted from a different film grain parameter set. predict_luma_scaling equal to 1 indicates that the luma scaling functions in the current film grain parameter set are predicted from a different film grain parameter set indicated by film_grain_param_set_idx_for_prediction.

luma_scaling_mult specifies a multiplier used for predicting the luma film grain scaling function.

luma_scaling_add specifies an addition/intercept parameter used for predicting the luma film grain scaling function.

When the predict_luma_scaling parameter is equal to 1, the luma scaling function values can be derived as follows:

```
num_luma_points set equal to num_luma_points in the film grain parameters set
film_grain_param_set_idx_for_prediction. Values point_y_value_ref [i] are equal to
point_y_value [i] in the film grain parameters set
ilm_grain_param_set_idx_for_prediction.
Values of point_y_scaling_ref [i] are equal to point_y_scaling [i] in the film grain
parameters set film_grain_param_set_idx_for_prediction.
for ( i = 0; i < num_luma_points; i++ ) {
  point_y_value[ i ] = point_y_value_ref[ i ]
  point_y_scaling[ i ] =
    Clip3(0, 255, ( (point_y_scaling_ref[ i ] * (luma_scaling_mult − 256) + 8) >>
    4) + luma_scaling_add − 256)
}
```

For example, luma_scaling_mult could represent a value of multiplier from −16 to +15.9375 with granularity of values of 1/16, and luma_scaling_add could represent an integer value of intercept in the range between [−256, 255].

predict_cb_scaling equal to 0 indicates that the Cb scaling functions in the current film grain parameter set are not predicted from a different film grain parameter set. predict_cb_scaling equal to 1 indicates that the Cb scaling functions in the current film grain parameter set are predicted from a film grain parameter set indicated by film_grain_param_set_idx_for_prediction. If predict_cb_scaling is equal to 1, variables cb_mult, cb_luma_mult, and cb_offset are set equal to variables cb_mult, cb_luma_mult, and cb_offset in the film grain parameter set indicated by film_grain_param_set_idx_for_prediction.

cb_scaling_mult specifies a multiplier used for predicting the Cb film grain scaling function.

cb_scaling_add specifies an addition/intercept parameter used for predicting the Cb film grain scaling function.

When the predict_cb_scaling parameter is equal to 1, the Cb scaling function values can be derived as follows:

```
num_cb_points set equal to num_cb_points in the film grain parameters set
film_grain_param_set_idx_for_prediction. Values point_cb_value_ref [i] are equal to
point_cb_value [i] in the film grain parameters set
film_grain_param_set_idx_for_prediction. Values of point_cb_scaling_ref [i] are equal to
point_cb_scaling [i] in the film grain parameters set
film_grain_param_set_idx_for_prediction.
for ( i = 0; i < num_cb_points; i++ ) {
  point_cb_value[ i ] = point_cb_value_ref[ i ]
  point_cb_scaling[ i ] =
    Clip3(0, 255, ( (point_cb_scaling_ref[ i ] * (cb_scaling_mult − 256) + 8) >>
    4) + cb_scaling_add − 256)
}
```

For example, cb_scaling_mult could represent a value of multiplier from −16 to +15.9375 with granularity of values of 1/16, and cb_scaling_add could represent an integer value of intercept in the range between [−256, 255].

predict_cr_scaling equal to 0 indicates that the Cr scaling functions in the current film grain parameter set are not predicted from a different film grain parameter set. predict_cr_scaling equal to 1 indicates that the Cr scaling functions in the current film grain parameter set are predicted from a film grain parameter set indicated by film_grain_param_set_idx_for_prediction.

If predict_cr_scaling is equal to 1, variables cr_mult, cr_luma_mult, and cr_offset are set equal to variables cr_mult, cr_luma_mult, and cr_offset in the film grain parameter set indicated by film_grain_param_set_idx_for_prediction.

cr_scaling_mult specifies a multiplier used for predicting the Cr film grain scaling function.

cr_scaling_add specifies an addition/intercept parameter used for predicting the Cr film grain scaling function. When predict_cr_scaling parameters is equal to 1, the Cr scaling function values can be derived as follows.

```
num_cr_points set equal to num_cr_points in the film grain parameters set
film_grain_param_set_idx_for_prediction. Values point_cr_value_ref [i] are equal to
point_cr_value [i] in the film grain parameters set
film_grain_param_set_idx_for_prediction.
Values of point_cr_scaling_ref [i] are equal to point_cr_scaling [i] in the film grain
parameters set
film_grain_param_set_idx_for_prediction.
for ( i = 0; i < num_cr_points; i++ ) {
  point_cr_value[ i ] = point_cr_value_ref[ i ]
  point_cr_scaling[ i ] =
    Clip3(0, 255, ( (point_cr_scaling_ref[ i ] * (cr_scaling_mult − 256) + 8) >> 4)
    +cr_scaling_add − 256)
}
```

For example, cr_scaling_mult can represent a value of multiplier from −16 to +15.9375 with granularity of values of 1/16, and cr_scaling_add can represent an integer value of intercept in the range between [−256, 255].

Exemplar syntax for compact representations of scaling parameters that also includes the residuals between predictions of scaling functions and actual scaling functions is shown below in Table 2.

TABLE 2

| | *Type* |
|---|---|
| av1_film_grain_params( ) | |
| predict_scaling | f(1) |
| if (predict_scaling) | |
| film_grain_param_set_idx_for_prediction | f(3) |
| if (predict_scaling) { | |
| predict_luma_scaling | f(1) |
| if (predict_luma_scaling) { | |
| luma_scaling_mult | f(9) |
| luma_scaling_add | f(9) |
| num_y_points (alternatively, may be obtained from | f(4) |
| reference set) | |
| bits_per_y_scaling_res | f(3) |
| BitsRes = bits_per_y_scaling_res | |
| for ( i = 0; i < num_y_points; i++ ) | |
| point_y_scaling_res[ i ] f(BitsRes) | |
| y_scaling_res_granularity | f(3) |
| } else { | |
| num_y_points | f(4) |
| for ( i = 0; i < num_y_points; i++ ) { | |
| point_y_value[ i ] | f(8) |
| point_y_scaling[ i ] | f(8) |
| } | |
| } | |
| luma_only_grain | f(1) |
| if ( luma_only_grain ) { | |
| chroma_scaling_from_luma = 0 | |
| } else { | |
| chroma_scaling_from_luma | f(1) |
| } | |
| if ( luma_only_grain \|\| chroma_scaling_from_luma ) { | |
| num_cb_points = 0 | |
| num_cr_points = 0 | |
| } else { | |
| if (predict_scaling) { | |
| predict_cb_scaling | f(1) |
| if (predict_cb_scaling) { | |
| cb_scaling_mult | f(9) |
| cb_scaling_add | f(9) |
| num_cb_points = 0 | |
| num_cb_points_in_ref | f(4) |
| bits_per_cb_scaling_res | f(3) |
| BitsRes = bits_per_cb_scaling_res | |
| for ( i = 0; i < num_cb_points_in_ref; i++ ) | |
| point_cb_scaling_res[ i ] | f(BitsRes) |
| cb_scaling_res_granularity | f(3) |
| } else { | |
| num_cb_points | f(4) |
| for ( i = 0; i < num_cb_points; i++ ) { | |
| point_cb_value[ i ] | f(8) |
| point_cb_scaling[ i ] | f(8) |
| } | |
| } | |
| if (predict_scaling) { | |
| predict_cr_scaling | f(1) |
| if (predict_cr_scaling) { | |
| cr_scaling_mult | f(9) |
| cr_scaling_add | f(9) |
| num_cr_points = 0 | |
| num_cr_points_in_ref | f(4) |
| bits_per_cr_scaling_res | f(3) |
| BitsRes = bits_per_cr_scaling_res | |
| for ( i = 0; i < num_cr_points_in_ref; i++ ) | |
| point_cr_scaling_res[ i ] | f(BitsRes) |
| cr_scaling_res_granularity | f(3) |
| } else { | |
| num_cr_points | f(4) |
| for ( i = 0; i < num_cr_points; i++ ) { | |
| point_cr_value[ i ] | f(8) |
| point_cr_scaling[ i ] | f(8) |
| } | |
| } | |
| grain_scaling_minus_8 | f(2) |
| ar_coeff_lag | f(2) |
| numPosLuma = 2 * ar_coeff_lag * ( ar_coeff_lag + 1 ) | |
| if ( num_y_points \|\| predict_luma_scaling ) { | |
| numPosChroma = numPosLuma + 1 | |
| for ( i = 0; i < numPosLuma; i++ ) | |
| ar_coeffs_y_plus_128[ i ] | f(8) |
| } else { | |
| numPosChroma = numPosLuma | |
| } | |
| if ( chroma_scaling_from_luma \|\| num_cb_points \|\| | |
| predict_cb_scaling ) { | |
| for ( i = 0; i < numPosChroma; i++ ) | |
| ar_coeffs_cb_plus_128[ i ] | f(8) |
| } | |
| if ( chroma_scaling_from_luma \|\| num_cr_points \|\| | |
| predict_cr_scaling) { | |
| for ( i = 0; i < numPosChroma; i++ ) | |
| ar_coeffs_cr_plus_128[ i ] | f(8) |
| } | |

In Table 2, predict_scaling equal to 0 specifies that scaling functions in the current film grain parameter set are not predicted from scaling functions that belong to other film grain parameters sets. predict_scaling equal to 1 specifies that scaling functions in the current film grain parameter set may be predicted from scaling functions that belong to other film grain parameters sets.

film_grain_param_set_idx_for_prediction specifies an index of a film grain parameter set that is used for prediction of scaling functions of the current film grain parameter set. It can be a requirement of the conformance to the current specification that the values of the film grain parameter set with index film_grain_param_set_idx_for_prediction has been initialized with values of the scaling functions that in the current coded video sequence.

predict_luma_scaling equal to 0 indicates that the luma scaling functions in the current film grain parameter set are not predicted from a different film grain parameter set. predict_luma_scaling equal to 1 indicates that the luma scaling functions in the current film grain parameter set are predicted from a different film grain parameter set indicated by film_grain_param_set_idx_for_prediction.

luma_scaling_mult specifies a multiplier used for predicting the luma film grain scaling function.

luma_scaling_add specifies an addition/intercept parameter used for predicting the luma film grain scaling function.

num_y_points_in_ref specifies the number of points for the piecewise linear scaling function of the luma component in the film grain parameter set referenced with film_grain_param_set_idx_for_prediction.

bits_per_y_scaling_res specifies the number of bits used for encoding of differences/residuals for point_y_scaling.

point_y_scaling_res [i] specifies the prediction difference of the parameters. The parameter is signaled using bits_per_y_scaling_res bits and is in the [−2 bits_per_y_value_res-1, 2bits_per_y_value_res-1-1] range.

y_scaling_res_granularity specifies the granularity with which the difference values for the predicted scaling function are encoded.

When the predict_luma_scaling parameter is equal to 1, the luma scaling function values can be derived as follows: num_luma_points set equal to num_luma_points in the film grain parameters set film_grain_param_set_idx_for_prediction. Values point_y_value_ref [i] are equal to point_y_value [i] in the film grain parameters set film_grain_param_set_idx_for_prediction. Values of point_y_scaling_ref [i] are equal to point_y_scaling [i] in the film grain parameters set film_grain_param_set_idx_for_prediction.

```
for ( i = 0; i < num_luma_points; i++ ) {
  point_y_value[ i ] = point_y_value_ref[ i ]
  point_y_scaling[ i ] =
    Clip3(0, 255, ( (point_y_scaling_ref[ i ] * (luma_scaling_mult −
    256) + 8) >> 4) + luma_scaling_add − 256 +
    (point_y_scaling_res[ i] − (1 << (bits_per_y_scaling_res−1) ) ) *
    y_scaling_res_granularity )
}
```

For example, luma_scaling_mult could represent a value of multiplier from −16 to +15.9375 with granularity of values of 1/16, and luma_scaling_add could represent an integer value of intercept in the range between [−256, 255].

predict_cb_scaling equal to 0 indicates that the Cb scaling functions in the current film grain parameter set are not predicted from a different film grain parameter set. predict_cb_scaling equal to 1 indicates that the Cb scaling functions in the current film grain parameter set are predicted from a film grain parameter set indicated by film_grain_param_set_idx_for_prediction.

If predict_cb_scaling is equal to 1, variables cb_mult, cb_luma_mult, and cb_offset are set equal to variables cb_mult, cb_luma_mult, and cb_offset in the film grain parameter set indicated by film_grain_param_set_idx_for_prediction.

cb_scaling_mult specifies a multiplier used for predicting the Cb film grain scaling function.

cb_scaling_add specifies an addition/intercept parameter used for predicting the Cb film grain scaling function.

num_cb_points_in_ref specifies the number of points for the piecewise linear scaling function of the luma component in the film grain parameter set referenced with film_grain_param_set_idx_for_prediction.

bits_per_cb_scaling_res specifies the number of bits used for encoding of differences/residuals for point_cb_scaling.

point_cb_scaling_res [i] specifies the prediction difference of the parameters. The parameter is signaled using bits_per_cb_scaling_res bits and is in the [−2 bits_per_cb_value_res-1, 2bits_per_cb_value_res-1-1] range.

cb_scaling_res_granularity specifies the granularity with which the difference values for the predicted scaling function are encoded. When the predict_cb_scaling parameter is equal to 1, the Cb scaling function values can be derived as follows: num_cb_points set equal to num_cb_points in the film grain parameters set film_grain_param_set_idx_for_prediction. Values point_cb_value_ref [i] are equal to point_cb_value [i] in the film grain parameters set film_grain_param_set_idx_for_prediction. Values of point_cb_scaling_ref [i] are equal to point_cb_scaling [i] in the film grain parameters set film_grain_param_set_idx_for_prediction.

```
for ( i = 0; i < num_cb_points; i++ ) {
  point_cb_value[ i ] = point_cb_value_ref[ i ]
  point_cb_scaling[ i ] =
    Clip3(0, 255, ( (point_cb_scaling_ref[ i ] * (cb_scaling_mult −
    256) + 8) >> 4) +
    cb_scaling_add − 256 + (point_cb_scaling_res[ i ] − (1 <<
    (bits_per_cb_scaling_res−1) ) ) * cb_scaling_res_granularity)
}
```

For example, cb_scaling_mult could represent a value of multiplier from −16 to +15.9375 with granularity of values of 1/16. cb_scaling_add could represent an integer value of intercept in the range between [−256, 255].

predict_cr_scaling equal to 0 indicates that the Cr scaling functions in the current film grain parameter set are not predicted from a different film grain parameter set. predict_cr_scaling equal to 1 indicates that the Cr scaling functions in the current film grain parameter set are predicted from a film grain parameter set indicated by film_grain_param_set_idx_for_prediction.

If predict_cr_scaling is equal to 1, variables cr_mult, cr_luma_mult, and cr_offset are set equal to variables cr_mult, cr_luma_mult, and cr_offset in the film grain parameter set indicated by film_grain_param_set_idx_for_prediction.

cr_scaling_mult specifies a multiplier used for predicting the Cr film grain scaling function.

cr_scaling_add specifies an addition/intercept parameter used for predicting the Cr film grain scaling function.

num_cr_points_in_ref specifies the number of points for the piecewise linear scaling function of the luma component in the film grain parameter set referenced with film_grain_param_set_idx_for_prediction.

bits_per_cr_scaling_res specifies the number of bits used for encoding of differences/residuals for point_cb_scaling.

point_cr_scaling_res [i] specifies the prediction difference of the parameters. The parameter is signaled using bits_per_cb_scaling_res bits and is in the [−2 bits_per_cr_value_res−1, 2bits_per_cr_value_res-1-1] range.

cr_scaling_res_granularity specifies the granularity with which the difference values for the predicted scaling function are encoded.

When the predict_cr_scaling parameter is equal to 1, the Cr scaling function values can be derived as follows: num_cr_points set equal to num_cr_points in the film grain parameters set film_grain_param_set_idx_for_prediction. Values point_cr_value_ref [i] are equal to point_cr_value [i] in the film grain parameters set film_grain_param_set_idx_for_prediction. Values of point_cr_scaling_ref [i] are equal to point_cr_scaling [i] in the film grain parameters set film_grain_param_set_idx_for_prediction.

```
for ( i = 0; i < num_cr_points; i++ ) {
  point_cr_value[ i ] = point_cr_value_ref[ i ]
  point_cr_scaling[ i ] =
    Clip3(0, 255, ( (point_cr_scaling_ref[ i ] * (cr_scaling_mult −
    256) + 8) >> 4) +
    cr_scaling_add − 256 + (point_cr_scaling_res[ i ] − (1 <<
    (bits_per_cr_scaling_res−1) )) *
    cr_scaling_res_granularity)
}
```

For example, cr_scaling_mult could represent a value of multiplier from −16 to +15.9375 with granularity of values of 1/16, and cr_scaling_add could represent an integer value of intercept in the range between [−256, 255].

Exemplar syntax for compact representations of scaling parameters that encodes (e.g., using a lossy encoding technique) the residuals between predictions of scaling functions and actual scaling functions is shown below in Table 3.

TABLE 3

| | *Type* |
|---|---|
| av1_film_grain_params( ) | |
| predict_scaling | f(1) |
| if (predict_scaling) | |
| film_grain_param_set_idx_for_prediction | f(3) |
| if (predict_scaling) { | |
| predict_luma_scaling | f(1) |
| if (predict_luma_scaling) { | |
| luma_scaling_mult_plus_256 | f(9) |
| luma_scaling_add_plus_256 | f(9) |
| num_y_points | f(4) |
| bits_per_y_scaling_res | f(3) |
| BitsRes = bits_per_y_scaling_res | |
| if (BitsRes) { | |
| for ( i = 0; i < num_y_points; i++ ) | |
| point_y_value[ i ] | f(8) |
| point_y_scaling_res[ i ] | f(BitsRes) |
| y_scaling_res_granularity | f(3) |
| } | |
| } else { | |
| num_y_points | f(4) |
| for ( i = 0; i < num_y_points; i++ ) { | |
| point_y_value[ i ] | f(8) |
| point_y_scaling[ i ] | f(8) |
| } | |
| } | |
| luma_only_grain f(1) | |
| if ( luma_only_grain ) { | |
| chroma_scaling_from_luma = 0 | |
| } else { | |
| chroma_scaling_from_luma | f(1) |
| } | |
| if ( luma_only_grain \|\| chroma_scaling_from_luma ) { | |
| num_cb_points = 0 | |
| num_cr_points = 0 | |
| } else { | |
| if (predict_scaling) { | |
| predict_cb_scaling | f(1) |
| if (predict_cb_scaling) { | |
| cb_scaling_mult_plus_256 | f(9) |
| cb_scaling_add_plus_256 | f(9) |
| num_cb_points | f(4) |
| num_cb_points_in_ref | f(4) |
| bits_per_cb_scaling_res | f(3) |
| BitsRes = bits_per_y_scaling_res | |
| if (BitsRes) { | |
| for ( i = 0; i < num_cb_points; i++ ) | |
| point_cb_value[ i ] | f(8) |
| point_cb_scaling_res[ i ] f(BitsRes) | |
| cb_scaling_res_granularity | f(3) |
| } | |
| } else { | |
| num_cb_points | f(4) |
| for ( i = 0; i < num_cb_points; i++ ) { | |
| point_cb_value[ i ] | f(8) |
| point_cb_scaling[ i ] | f(8) |
| } | |
| } | |
| if (predict_scaling) { | |
| predict_cr_scaling | f(1) |
| if (predict_cr_scaling) { | |
| cr_scaling_mult_plus_256 | f(9) |
| cr_scaling_add_plus_256 | f(9) |
| num_cr_points | f(4) |
| num_cr_points_in | f(4) |
| bits_per_cr_scaling_res | f(3) |
| BitsRes = bits_per_y_scaling_res | |
| if (BitsRes) { | |
| for ( i = 0; i < num_cr_points; i++ ) | |
| point_cr_value[ i ] | f(8) |
| point_cr_scaling_res[ i ] | f(BitsRes) |
| cr_scaling_res_granularity | f(3) |
| } | |
| } else { | |
| num_cr_points | f(4) |
| for ( i = 0; i < num_cr_points; i++ ) { | |
| point_cr_value[ i ] | f(8) |
| point_cr_scaling[ i ] | f(8) |
| } | |
| } | |
| } | |
| grain_scaling_minus_8 | f(2) |
| ar_coeff_lag | f(2) |
| numPosLuma = 2 * ar_coeff_lag * ( ar_coeff_lag + 1 ) | |
| if ( num_y_points \|\| predict_luma_scaling ) { | |
| numPosChroma = numPosLuma + 1 | |
| for ( i = 0; i < numPosLuma; i++ ) | |
| ar_coeffs_y_plus_128[ i] | f(8) |
| } else { | |
| numPosChroma = numPosLuma | |
| } | |
| if ( chroma_scaling_from_luma \|\| num_cb_points \|\| | |
| predict_cb_scaling ) { | |
| for ( i = 0; i < numPosChroma; i++ ) | |
| ar_coeffs_cb_plus_128[ i ] | f(8) |
| } | |
| if ( chroma_scaling_from_luma \|\| num_cr_points \|\| | |
| predict_cr_scaling) { | |
| for ( i = 0; i < numPosChroma; i++ ) | |
| ar_coeffs_cr_plus_128[ i ] | f(8) |
| } | |

In Table 3, predict_scaling equal to 0 specifies that scaling functions in the current film grain parameter set are not predicted from scaling functions that belong to other film grain parameters sets. predict_scaling equal to 1 specifies that scaling functions in the current film grain parameter set may be predicted from scaling functions that belong to other film grain parameters sets.

film_grain_param_set_idx_for_prediction specifies an index of a film grain parameter set that is used for prediction of scaling functions of the current film grain parameter set. It can be a requirement of the conformance to the current specification that the values of the film grain parameter set with index film_grain_param_set_idx_for_prediction has been initialized with values of the scaling functions that in the current coded video sequence.

predict_luma_scaling equal to 0 indicates that the luma scaling functions in the current film grain parameter set are not predicted from a different film grain parameter set. predict_luma_scaling equal to 1 indicates that the luma scaling functions in the current film grain parameter set are predicted from a different film grain parameter set indicated by film_grain_param_set_idx_for_prediction.

luma_scaling_mult_plus_256 specifies a multiplier used for predicting the luma film grain scaling function.

luma_scaling_add_plus_256 specifies an addition/intercept parameter used for predicting the luma film grain scaling function.

num_y_points_in_ref specifies the number of points for the piecewise linear scaling function of the luma component in the film grain parameter set referenced with film_grain_param_set_idx_for_prediction.

bits_per_y_scaling_res specifies the number of bits used for encoding of differences/residuals for point_y_scaling.

point_y_scaling_res [i] specifies the prediction difference of the parameters. The parameter is signaled using bits_per_y_scaling_res bits and is in the [-2 bits_per_y_value_res-1, 2bits_per_y_value_res-1-1] range.

y_scaling_res_granularity specifies the granularity with which the difference values for the predicted scaling function are encoded.

When the predict_luma_scaling parameter is equal to 1, the luma scaling function values can be derived as follows: Unlike alternative 1, the num_luma_points is parsed from the bitstream explicitly. Values of point_y_scaling_ref [i] are determined by interpolating the piecewise-linear function (point_y_value [i], point_y_scaling [i]) in the film grain parameters set film_grain_param_set_idx_for_prediction at the locations point_y_value [i] of the current resolution. An example of the interpolation algorithm used is the scaling lookup initialization process from the AOMedia Film Grain Synthesis 1 (AFGS1) specification.

```
for ( i = 0; i < num_luma_points; i++ ) {
  point_y_scaling[ i ] =
    Clip3(0, 255, ( (point_y_scaling_ref[ i ] * (luma_scaling_mult_plus_256 −
    256) + 8) >> 4) + luma_scaling_add_plus_256 − 256 +
    (point_y_scaling_res[ i ] − ( 1 << (bits_per_y_scaling_res−1) ) )*
    y_scaling_res_granularity )
}
```

For example, luma_scaling_mult could represent a value of multiplier from −16 to +15.9375 with granularity of values of 1/16, and luma_scaling_add could represent an integer value of intercept in the range between [−256, 255].

predict_cb_scaling equal to 0 indicates that the Cb scaling functions in the current film grain parameter set are not predicted from a different film grain parameter set. predict_cb_scaling equal to 1 indicates that the Cb scaling functions in the current film grain parameter set are predicted from a film grain parameter set indicated by film_grain_param_set_idx_for_prediction. If predict_cb_scaling is equal to 1, variables cb_mult, cb_luma_mult, and cb_offset are set equal to variables cb_mult, cb_luma_mult, and cb_offset in the film grain parameter set indicated by film_grain_param_set_idx_for_prediction.

cb_scaling_mult_plus_256 specifies a multiplier used for predicting the Cb film grain scaling function.

cb_scaling_add_plus_256 specifies an addition/intercept parameter used for predicting the Cb film grain scaling function.

num_cb_points_in_ref specifies the number of points for the piecewise linear scaling function of the luma component in the film grain parameter set referenced with film_grain_param_set_idx_for_prediction.

bits_per_cb_scaling_res specifies the number of bits used for encoding of differences/residuals for point_cb_scaling.

point_cb_scaling_res [i] specifies the prediction difference of the parameters. The parameter is signaled using bits_per_cb_scaling_res bits and is in the [−2 bits_per_y_value_res-1, 2bits_per_y_value_res-1-1] range.

cb_scaling_res_granularity specifies the granularity with which the difference values for the predicted scaling function are encoded. When the predict_cb_scaling parameter is equal to 1, the Cb scaling function values can be derived as follows: Unlike alternative 1, the num_cb_points is parsed from the bitstream explicitly. Values of point_cb_scaling_ref [i] are determined by interpolating the piecewise-linear function (point_cb_value [i], point_cb_scaling [i]) in the film grain parameters set film_grain_param_set_idx_for_prediction at the locations point_cb_value [i] of the current resolution. An example of the interpolation algorithm used is the scaling lookup initialization process from the AOMedia Film Grain Synthesis 1 (AFGS1) specification.

```
for ( i = 0; i < num_cb_points; i++ ) {
  point_cb_scaling[ i ] =
    Clip3(0, 255, ( (point_cb_scaling_ref[ i ] * (cb_scaling_mult_plus_256 −
    256) + 8) >> 4) + cb_scaling_add_plus_256 − 256 +
    (point_cb_scaling_res[ i ] − ( 1 << (bits_per_cb_scaling_res−1) ) ) *
    cb_scaling_res_granularity)
}
```

Here and in some alternative embodiments, the value of 256 is used as the factor to signal negative values of cb_scaling_add. The signaled value of the cb_scaling_add_plus_256 is a positive integer, and subtracting a value between 0 and the maximum value of cb_scaling_add_plus_256 results in the interval that has both positive and negative values. Such a value may or may not be the midpoint of the interval (i.e. the interval may or may not be symmetric around zero). For example, cb_scaling_mult could represent a value of multiplier from −16 to +15.9375 with granularity of values of 1/16. cb_scaling_add could represent an integer value of intercept in the range between [−256, 255].

predict_cr_scaling equal to 0 indicates that the Cr scaling functions in the current film grain parameter set are not predicted from a different film grain parameter set. predict_cr_scaling equal to 1 indicates that the Cr scaling functions in the current film grain parameter set are predicted from a film grain parameter set indicated by film_grain_param_set_idx_for_prediction. If predict_cr_scaling is equal to 1, variables cr_mult, cr_luma_mult, and cr_offset are set equal to variables cr_mult, cr_luma_mult, and cr_offset in the film grain parameter set indicated by film_grain_param_set_idx_for_prediction.

cr_scaling_mult_plus_256 specifies a multiplier used for predicting the Cr film grain scaling function.

cr_scaling_add_plus_256 specifies an addition/intercept parameter used for predicting the Cr film grain scaling function.

num_cr_points_in_ref specifies the number of points for the piecewise linear scaling function of the luma component in the film grain parameter set referenced with film_grain_param_set_idx_for_prediction.

bits_per_cr_scaling_res specifies the number of bits used for encoding of differences/residuals for point_cb_scaling. point_cr_scaling_res [i] specifies the prediction difference of the parameters. The parameter is signaled using bits_per_cb_scaling_res bits and is in the [−2 bits_per_cr_value_res-1, 2bits_per_cr_value_res-1-1] range.

cr_scaling_res_granularity specifies the granularity with which the difference values for the predicted scaling function are encoded.

When the predict_cr_scaling parameter is equal to 1, the Cr scaling function values can be derived as follows: Unlike alternative 1, the num_cr_points is parsed from the bitstream explicitly. Values of point_cr_scaling_ref [i] are determined by interpolating the piecewise-linear function (point_cr_value [i], point_cr_scaling [i]) in the film grain parameters set film_grain_param_set_idx_for_prediction at the locations point_cr_value [i] of the current resolution. An example of the interpolation algorithm used is the scaling lookup initialization process from the AFGS1 specification.

```
for ( i = 0; i < num_cr_points; i++ ) {
  point_cr_scaling[ i ] =
    Clip3(0, 255, ( (point_cr_scaling_ref[ i ] * (cr_scaling_mult − 256) + 8) >> 4)
    + cr_scaling_add − 256 + (point_cr_scaling_res[ i ] − ( 1 <<
    (bits_per_cr_scaling_res−1) )) * cr_scaling_res_granularity)
}
```

For example, cr_scaling_mult could represent a value of multiplier from −16 to +15.9375 with granularity of values of 1/16. cr_scaling_add could represent an integer value of intercept in the range between [−256, 255].

Exemplar syntax for compact representations of scaling parameters that include increments of x-axis values of scaling functions is shown below in Table 4.

TABLE 4

| | |
|---|---|
| num_y_points | f(4) |
| point_y_value_increment_bits_minus1 | f(3) |
| BitsIncr = point_y_value_increment_bits_minus1 + 1 | |
| point_y_value[ −1 ] = 0 | |
| for ( i = 0; i < num_y_points; i++ ) { | |
| point_y_value_increment[ i ] f(BitsIncr) | |
| point_y_value[ i ] = point_y_value[ i − 1 ] + | |
| point_y_value_increment[ i ] | |
| point_y_scaling[ i ] f(8) | |
| } | |
| } | |

In Table 4, point_y_value_increment_bits_minus1 specifies the number of bits minus 1 that will be spent on signaling the increments of point_y_values.

An alternative is to use the following:

point_y_value_increment_bits_minus5 specifies the number of bits minus 5 that will be spent on signaling the increments of point_y_values.

point_y_value_increment [i] is the increment of point_y_value [i] relative to the point_y_value [i-1]. point_y_value [i] represents the x (luma value) coordinate for the i-th point of the piecewise linear scaling function for the luma component. The values are signaled on the scale of 0 . . . 255. (In case of 10-bit video, these values correspond to luma values divided by 4. In case of 12-bit video, these values correspond to luma values divided by 16.)

The values of point_y_value [i] can be obtained as follows:

point_y_value [−1]=0 (such a value is not used in determining the scaling function and is intended to be used as the first value in the loop below).

```
for ( i = 0; i < num_y_points; i++ )
  point_y_value[ i ] = point_y_value[ i − 1 ] +
  point_y_value_increment[ i ]
```

Exemplar syntax for compact representations of scaling parameters that use a common offset for signaling y-axis values of scaling functions is shown below in Tables 5-6.

TABLE 5

| | |
|---|---|
| num_y_points | f(4) |
| point_y_value_increment_bits_minus1 | f(3) |
| BitsIncr = point_y_value_increment_bits_minus1 + 1 | |
| point_y_value[ −1 ] = 0 | |
| point_y_scaling_bits_minus5 | f(3) |
| BitsScal = point_y_scaling_bits_minus5 + 5 | |
| for ( i = 0; i < num_y_points; i++ ) { | |
| point_y_value_increment[ i ] | f(BitsIncr) |
| point_y_value[ i ] = point_y_value[ i − 1 ] + | |
| point_y_value_increment[ i ] | |
| point_y_scaling[ i ] | f(BitsScal) |
| } | |
| } | |

In Table 5, point_y_value_increment_bits_minus1 specifies the number of bits minus 4 that will be spent on signaling the increments of point_y_values.

point_y_value_increment [i] specifies the increment of point_y_value [i] relative to the point_y_value [i-1]. point_y_value [i] represents the x (luma value) coordinate for the i-th point of the piecewise linear scaling function for the luma component. The values are signaled on the scale of 0 . . . 255. (In case of 10-bit video, these values correspond to luma values divided by 4. In case of 12-bit video, these values correspond to luma values divided by 16.)

The values of point_y_value [i] are obtained as follows: point_y_value [−1]=0 (such a value is not used in determining the scaling function and is intended to be used as the first value in the loop below).

```
for ( i = 0; i < num_y_points; i++ )
  point_y_value[ i ] = point_y_value[ i − 1 ] +
  point_y_value_increment[ i ]
```

point_y_scaling_bits_minus5 specifies the number of bits minus 5 that will be spent on signaling the increments of point_y_scaling [i]

TABLE 6

| | |
|---|---|
| num_cb_points | f(4) |
| point_cb_value_increment_bits_minus1 | f(4) |
| BitsIncr = point_cb_value_increment_bits_minus1 + 1 | |
| point_cb_value[ −1 ] = 0 | |
| point_cb_scaling_bits_minus5 | f(2) |
| BitsScal = point_cb_scaling_bits_minus5 + 5 | |
| point_cb_scaling_offset | f(8) |
| for ( i = 0; i < num_cb_points; i++ ) { | |
| point_cb_value_increment[ i ] | f(BitsIncr) |
| point_cb_value[ i ] = point_cb_value[ i − 1 ] + | |
| point_cb_value_increment[ i ] | |
| point_cb_scaling_diff[ i ] | f(BitsScal) |
| } | |
| } | |

In Table 6, point_cb_value_increment_bits_minus1 specifies the number of bits minus 4 that will be spent on signaling the increments of point_y_values.

point_cb_scaling_offset specifies the offset that should be added to the point_cb_scaling_diff [i] to produce the point_cb_scaling [i].

```
for ( i = 0; i < num_cb_points; i++ ) {
  point_cb_scaling[ i ] = point_cb_scaling_diff[ i ] +
  point_cb_scaling_offset
```

point_cb_value_increment [i] specifies the increment of point_cb_value [i] relative to the point_cb_value [i-1]. point_cb_value [i] represents the x (luma value) coordinate for the i-th point of the piecewise linear scaling function for luma component. The values are signaled on the scale of 0 . . . 255. (In case of 10-bit video, these values correspond to luma values divided by 4. In case of 12-bit video, these values correspond to luma values divided by 16.)

The values of point_cb_value [i] can be obtained as follows: point_cb_value [−1]=0 (such a value is not used in determining the scaling function and is intended to be used as the first value in the loop below).

```
for ( i = 0; i < num_y_points; i++ )
  point_cb_value[ i ] = point_cb_value[ i − 1 ] +
  point_cb_value_increment[ i ]
```

point_cb_scaling_bits_minus5 specifies the number of bits minus 5 that will be spent on signaling the increments of point_cb_scaling [i].

Exemplar syntax for compact representations of scaling parameters that use increasingly fewer bits to encode x-axis increments of scaling functions is shown below in Table 7.

TABLE 7

| | |
|---|---|
| num_y_points | f(4) |
| point_y_value_increment_bits_minus1 | f(4) |
| BitsIncr = point_y_value_increment_bits_minus1 + 1 | |
| point_y_value[ −1 ] = 0 | |
| point_y_scaling_bits_minus5 | f(2) |
| BitsScal = point_y_scaling_bits_minus5 + 5 | |
| for ( i = 0; i < num_y_points; i++ ) { | |
| point_y_value_increment[ i ] | f(BitsIncr) |
| point_y_value[ i ] = point_y_value[ i −1 ] + | |
| point_y_value_increment[ i ] | |
| point_y_scaling[ i ] | f(BitsScal) |
| } | |
| } | |

In Table 7, point_y_value_increment_bits_minus1 specifies the number of bits minus 4 that will be spent on signaling the increments of point_y_values.

point_y_value_increment [i] specifies the increment of point_y_value [i] relative to the point_y_value [i-1]. point_y_value [i] represents the x (luma value) coordinate for the i-th point of the piecewise linear scaling function for the luma component. The values are signaled on the scale of 0 . . . 255. (In case of 10-bit video, these values correspond to luma values divided by 4. In case of 12-bit video, these values correspond to luma values divided by 16.)

The values of point_y_value [i] are obtained as follows: point_y_value [−1]=0 (such a value is not used in determining the scaling function and is intended to be used as the first value in the loop below).

```
for ( i = 0; i < num_y_points; i++ )
  point_y_value[ i ] = point_y_value[ i −1 ] +
  point_y_value_increment[ i
```

BitsIncr is set as follows. It starts with BitsIncr=point_y_value_increment_bits_minus1+1. Then, for each increment of index [i], the following evaluation is performed.

```
while (BitsIncr){
  if(max_y_value − point_y_value[ i ] ) < (1 << (BitsIncr − 1))
    BitsIncr = BitsIncr − 1
  else
    break
}
```

Combining with the equation above, the following algorithm can be performed

```
BitsIncr = point_y_value_increment_bits_minus1 + 1
for ( i = 0; i < num_y_points; i++ ) {
  read (point_y_value_increment[ i ](BitIncr) )
  point_y_value[ i ] = point_y_value[ i −1 ] +
  point_y_value_increment[ i ]
  while (BitsIncr){
    if(max_y_value − point_y_value[ i ] ) < (1 << (BitsIncr − 1))
      BitsIncr = BitsIncr − 1
    else
        break
  }
}
```

Exemplar syntax for compact representations that use fewer bits to encode template parameters is shown below in Table 8.

TABLE 8

| | |
|---|---|
| ar_coeff_lag | f(2) |
| numPosLuma = 2 * ar_coeff_lag * ( ar_coeff_lag + 1 ) | |
| bits_per_ar_coeff_y_minus5 | f(2) |
| BitsArY = bits_per_ar_coeff_y_minus5 + 5 | |
| if ( num_y_points \|\| predict_luma_scaling ) { | |
| numPosChroma = numPosLuma + 1 | |
| for ( i = 0; i < numPosLuma; i++ ) | |
| ar_coeffs_y[ i ] | f(BitsArY) |
| } else { | |
| numPosChroma = numPosLuma | |
| } | |

In Table 8, bits_per_ar_coeff_y_minus5 specifies the number of bits minus 5 that will be spent on signaling ar_coeffs_y.

The value of AY coefficients for the Y component can be derived as ar_coeffs_y [i]-(1<< (BitsArY-1)).

The AR coefficients for components Cb and Cr can be derived analogously.

Returning to FIG. 4, the client application 146 includes a decoder 430, and the decoder includes a decoding module 432 and a film grain synthesizer 434. In operation, the decoding module 432 decodes the encoded video content 422 from the encoder 116 to generate decoded video content (not shown). Any technically feasible decoding technique, including known decoding algorithms, can be used in some embodiments. The film grain synthesizer 434 uses the parameter metadata 426 transmitted by the encoder 116 to read the compact representations of film grain parameters from the bitstream 424. The film grain synthesizer 434 then determines the film grain parameters from the compact representations. For example, in some embodiments, the film grain synthesizer 434 can predict one or more scaling functions using linear functions and residuals in the compact representations, as described above. As another example, in some embodiments, the film grain synthesizer 434 can read, from the parameter bitstream 424, the limited number of bits with which each autoregressive model coefficient is encoded, as described above. Thereafter, the film grain synthesizer 434 synthesizes film grain based on the film grain parameters, as described above, and the film grain synthesizer 434 generates reconstructed video content 440 for output via a display device. The reconstructed video content 440 includes the decoded video content, which can also be upscaled to a display resolution, as well as the synthesized film grain.

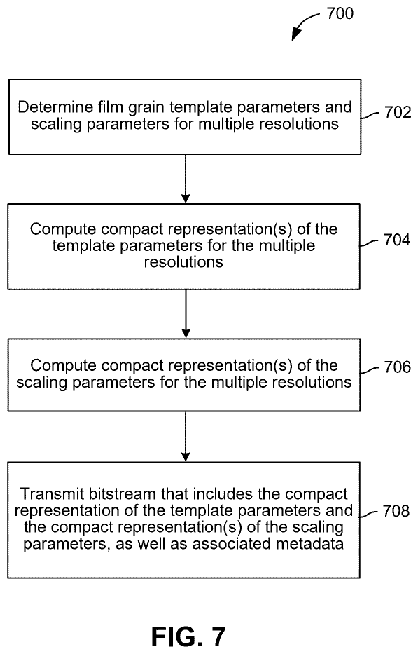

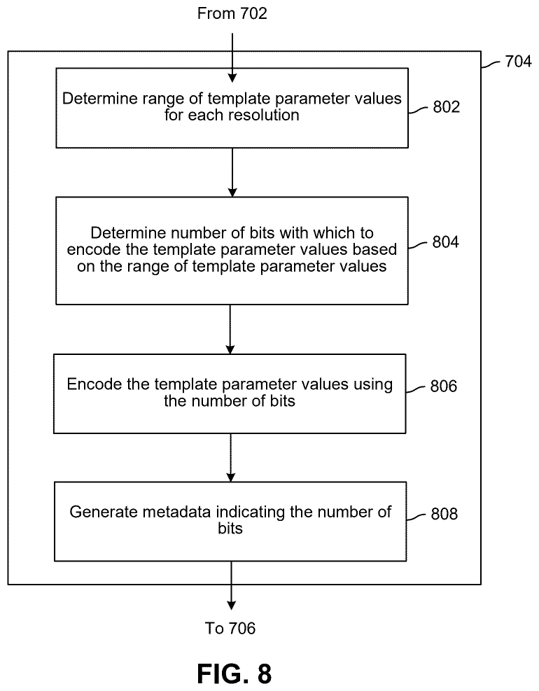

FIG. 7 is a flow diagram of method steps for signaling film grain parameters, according to various embodiments. Although the method steps are described with reference to the systems of FIGS. 1-4, persons skilled in the art will understand that any system configured to implement the method steps, in any order, falls within the scope of the present disclosure. In addition, in some embodiments, any subset of the steps 704-706 and the steps of FIGS. 8-10 can be performed.

As shown, a method 700 begins at step 702, where the film grain module 410 of the encoder 116 determines film grain template parameters and scaling parameters for multiple resolutions. In some embodiments, the film grain template parameters and scaling parameters for multiple resolutions can be determined according to the techniques disclosed in U.S. Pat. No. 10,839,489.

At step 704, the film grain module 410 computes one or more compact representations of the template parameters for the multiple resolutions. In some embodiments, the film grain module 410 can compute the compact representation of the template parameters for a given resolution by determining a range of the template parameter values associated with the given resolution, determining a number of bits with which to encode the template parameter values based on the range of template parameter values, and encoding the template parameter values using the number of bits, and the film grain module 410 can further generate metadata indicating the number of bits, as discussed in greater detail below in conjunction with FIG. 8.

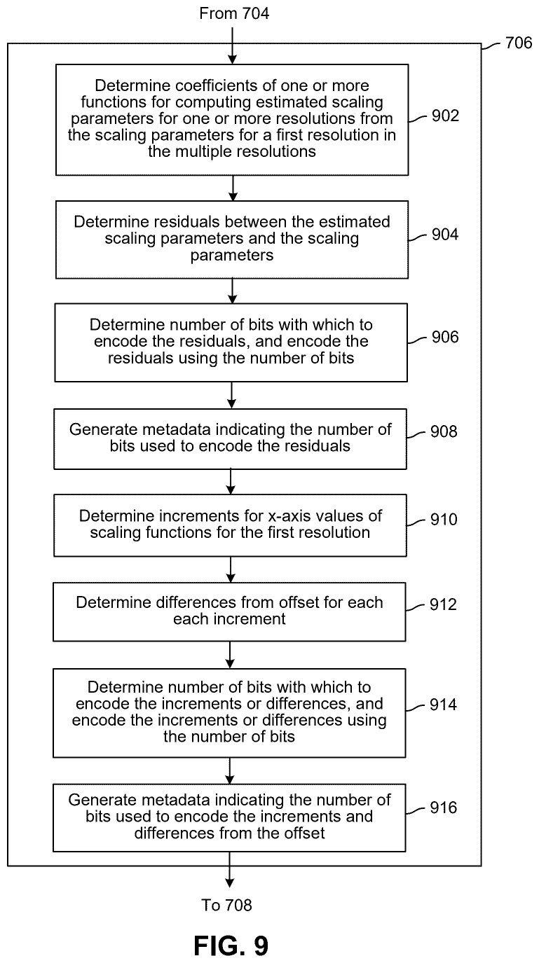

At step 706, the film grain module 410 computes one or more compact representations of the scaling parameters for the multiple resolutions. In some embodiments, compact representations that represent at least linear functions for predicting other scaling functions from one scaling function can be computed for a luma component and two chroma components. In some embodiments, the film grain module 410 can compute the compact representation(s) of the scaling parameters by determining coefficients of one or more functions for computing estimated scaling parameters for one or more resolutions from the scaling parameters for one of the multiple resolutions, determining residuals between the estimated scaling parameters and the scaling parameters, determining a number of bits with which to encode the residuals and encoding the residuals using the number of bits, generating metadata indicating the number of bits used to encode the residuals, determining increments for x-axis values of scaling functions for the multiple resolutions, determining a difference from an offset of each of the increments, and generating metadata indicating the number of bits used to encode the increments or offsets, as discussed in greater detail below in conjunction with FIG. 9. Although specific steps are shown in FIGS. 7-10, more generally, in some embodiments, any number of the techniques disclosed herein can be used separately or together to generate compact representations of template and/or scaling parameters.

At step 708, the film grain module 410 transmits, to a client application (e.g., a client application 146), a bitstream that includes the compact representation of the template parameters and the compact representation(s) of the scaling parameters, as well as associated metadata. In some embodiments, the metadata can specify bits in the bitstream that correspond to the compact representations of film grain parameters. Using the metadata, the client application can read the compact representations of film grain parameters from the bitstream, determine the film grain parameters from the compact representations, synthesize film grain based on the film grain parameters, and generate reconstructed video content for output that includes decoded video content, which can also be upscaled to display resolution, as well as the synthesized film grain, as discussed in greater detail below in conjunction with FIG. 10.

FIG. 8 is a flow diagram of method steps for generating one or more compact representations of template parameters at step 704 of the method 700, according to various embodiments. Although the method steps are described with reference to the systems of FIGS. 1-4, persons skilled in the art will understand that any system configured to implement the method steps, in any order, falls within the scope of the present disclosure.

As shown, at step 802, the film grain module 410 determines a range of the template parameter values determined at step 702 of the method 700, described above in conjunction with FIG. 7. The range of template parameter values is a range between a largest template parameter value and a smaller template parameter value.

At step 804, the film grain module 410 determines a number of bits with which to encode the template parameter values based on the range of template parameter values. In some embodiments, the number of bits is a minimum number of bits required to represent the values within the range of the template parameter values.

At step 806, the film grain module 410 encodes each of the template parameter values using the number of bits determined at step 804.

At step 808, the film grain module 410 generates metadata indicating the number of bits. Such metadata can be used to read the number of bits corresponding to the template parameter values from a bitstream (e.g., parameter bitstream 424) that includes the template parameter values encoded at step 806.

FIG. 9 is a flow diagram of method steps for generating compact representation(s) of scaling parameters at step 706 of the method 700, according to various embodiments. Although the method steps are described with reference to the systems of FIGS. 1-4, persons skilled in the art will understand that any system configured to implement the method steps, in any order, falls within the scope of the present disclosure.

As shown, at step 902, the film grain module 410 determines coefficients of one or more functions for computing estimated scaling parameters for one or more resolutions from the scaling parameters for a first resolution in the multiple resolutions. In some embodiments, the one or more functions are linear functions having the form fi(Y)=a*fj(Y)+b, and the linear functions, including coefficients thereof, can be determined by performing a least square linear regression technique.

At step 904, the film grain module 410 determines residuals between the estimated scaling parameters and the actual scaling parameters. The residuals can include the differences between the predictions of the other scaling functions and the actual other scaling functions at one or more points.

At step 906, the film grain module 410 determines a number of bits with which to encode the residuals, and encodes the residuals using the number of bits. In some embodiments, the number of bits can be selected based on a lossy encoding technique that encodes the residuals to any suitable degree of precision.

At step 908, the film grain module 410 generates metadata indicating the number of bits used to encode the residuals. Such metadata can be used to read the number of bits corresponding to residuals from a bitstream (e.g., parameter bitstream 424) that includes the residual values encoded at step 906.

At step 910, the film grain module 410 determines increments for x-axis values of points on the scaling function for the first resolution. As described, the scaling functions can be piecewise linear functions in some embodiments, and, in such cases, the x-axis values can be x-coordinate values of points at the ends of linear segments of the piecewise linear function. The increments are differences in the x-axis between one point and a neighboring point on the piecewise linear functions.

At step 912, the film grain module 410 determines a difference from an offset for each of the increments. As described, the offset can be a fixed value, and the differences can be smaller, and therefore represented using fewer bits, than the increments themselves. In some embodiments, y-coordinate values in the parameters that define one or more scaling functions can also be represented as differences from an offset, such as by selecting an offset and encoding y values as a+bi, where a is constant, and bi varies for each sample. As described, in such cases, a prediction of a y-coordinate value can be based on the offset that is a common base rather than a previous sample value.

At step 914, the film grain module 410 determines a number of bits with which to encode the increments or differences, and encodes the increments or differences from the offset using the number of bits. As described, the number of bits can be a minimum number of bits required to encode the increments or differences from the offset, and the number of bit can decrease for higher x-axis values for which the increments cannot be larger than certain amounts that are determinable. In some embodiments in which y-coordinate values in the parameters that define scaling function(s) are represented as differences from an offset, the differences can be encoded in a similar manner using a minimum number of bits.

At step 916, the film grain module 410 generates metadata indicating the number of bits used to encode the increments or differences. Such metadata can be used to read the number of bits corresponding to increments or differences from a bitstream (e.g., parameter bitstream 424) that includes the increments or differences encoded at step 914.

FIG. 10 is a flow diagram of method steps for generating reconstructed video content using transmitted film grain parameters, according to various embodiments. Although the method steps are described with reference to the systems of FIGS. 1-4, persons skilled in the art will understand that any system configured to implement the method steps, in any order, falls within the scope of the present disclosure.

As shown, a method 1000 begins at step 1002, where the decoder 430 receives a bitstream that includes one or more compact representations of template parameters and/or scaling parameters, as well as associated metadata. The decoder 430 can also receive an encoded video that the decoder 430 decodes according to any technically feasible decoding technique.

At step 1004, the decoder 430 reads the compact representation(s) of template parameters and the compact representation(s) of scaling parameters in the bitstream using the associated metadata. As described, the metadata can specify the bits corresponding to compact representation of the compact representation of template parameters and/or the compact representation of scaling parameters.

At step 1006, the decoder 430 synthesizes film grain based on the template parameters and/or the scaling parameters. Then, at step 1008, the decoder 430 applies the synthesized film grain to decoded media content to generate reconstructed media content. In some embodiments, the decoder 430 can determine the template parameters and the scaling parameters from the compact representation of the template parameters and the compact representation(s) of the scaling parameters, and the decoder 430 can then synthesize film grain and generate the reconstructed media content from the film grain and decoded video content as described above in conjunction with FIG. 4 and/or according to the techniques disclosed in U.S. Pat. No. 10,839,489.

At step 1010, the decoder 430 outputs the reconstructed media content via a display device. In some embodiments, any suitable signal can be transmitted to any technically feasible display device to cause the output of the reconstructed media content.

In sum, techniques are disclosed for transmitting compact representations of the film grain parameters. In some embodiments, the film grain parameters include parameters that define a set of scaling functions that indicate how the luma and chroma values of film grain are scaled for different resolutions of video content. In such cases, compact representations of the parameters that define the set of scaling functions can be generated by using a least square linear regression technique to compute the coefficients of linear functions so that one of the scaling functions can be used to obtain predictions of the other scaling functions, for example, through linear prediction of type f2(x)=a*f1(x)+b. In some embodiments, the compact representations further include residuals between the predictions of the other scaling functions and the actual other scaling functions. The residuals can be encoded using lossy encoding in some embodiments. In addition or alternatively, in some embodiments, compact representations of the parameters that define the set of scaling functions can be generated to include increments between x-coordinate values in the parameters that define each scaling function. In such cases, the increments can also be represented as a set of differences from an offset. In addition, the increments can be represented using fewer bits when the maximum possible size of the increments decrease. In some embodiments, y-coordinate values in the parameters that define the one or more scaling functions can also be represented as differences from an offset, such as by selecting an offset and encoding y values as a+bi, where a is constant, and bi varies for each sample.

In some embodiments, the film grain parameters include coefficients of an autoregressive model for computing a film grain template, portions of which can be applied as film grain to video content. In such cases, compact representations of the coefficients of the autoregressive model can use a limited number of bits to represent each coefficient. The limited number of bits can be determined as the number of bits required to represent values within a range of the coefficients of the autoregressive model.

An encoder can generate compact representations of film grain parameters using any combination of the foregoing techniques. The encoder can transmit the compact representations of film grain parameters, as well as encoded video content, to client applications. In particular, the compact representations of film grain parameters can be transmitted in a bitstream. In addition, the encoder can transmit metadata specifying bits in the bitstream corresponding to the compact representations of film grain parameters. Using such metadata, the client applications can read the compact representations of film grain parameters from the bitstream, determine the film grain parameters from the compact representations, synthesize film grain based on the film grain parameters, and generate reconstructed video content for output that includes decoded video content, which can also be upscaled to a display resolution, as well as the synthesized film grain.

At least one technical advantage of the disclosed techniques relative to the prior art is that, with the disclosed techniques, fewer bits corresponding to film grain parameters need to be transmitted to client devices during streaming sessions. The transmission of fewer bits corresponding to film grain parameters can reduce the amount of network bandwidth consumed when streaming video content, reduce delays in the playback of the video content, and/or increase the playback quality relative to prior art approaches. These technical advantages represent one or more technological improvements over prior art approaches.

1. In some embodiments, a computer-implemented method for transmitting film grain parameters to one or more client devices for use when playing back video content comprises generating, based on one or more film grain parameters associated with video content, one or more compact representations of the one or more film grain parameters, and transmitting the one or more compact representations to a client application executing on a client device, wherein the client application adds film grain to the video content, for playback, based on the one or more compact representations.

2. The computer-implemented method of clause 1, wherein the one or more film grain parameters define a plurality of scaling functions, and the one or more compact representations include one or more linear function coefficients for predicting at least one predicted scaling function based on a first scaling function included in the plurality of scaling functions.

3. The computer-implemented method of clauses 1 or 2, wherein the one or more compact representation further include one or more residuals between the at least one predicted scaling function and at least one corresponding scaling function included in the plurality of scaling functions.

4. The computer-implemented method of any of clauses 1-3, wherein the one or more compact representation further include a lossy encoding of one or more residuals between the at least one predicted scaling function and at least one corresponding scaling function included in the plurality of scaling functions.

5. The computer-implemented method of any of clauses 1-4, wherein the one or more film grain parameters include a set of x-coordinate values associated with a scaling function, and wherein the one or more compact representations include a set of increments associated with the set of x-coordinate values.

6. The computer-implemented method of any of clauses 1-5, wherein the set of increments is represented as a set of differences from an offset.

7. The computer-implemented method of any of clauses 1-6, wherein a first increment included in the set of increments is represented using fewer bits than a second increment included in the set of increments.

8. The computer-implemented method of any of clauses 1-7, wherein the one or more film grain parameters include a set of coefficients of an autoregressive model, and each coefficient included in the set of coefficients is represented in the one or more compact representations using a number of bits that is determined based on a range associated with the set of coefficients.

9. The computer-implemented method of any of clauses 1-8, further comprising transmitting metadata to the client device specifying the one or more compact representations.

10. The computer-implemented method of any of clauses 1-9, wherein the one or more film grain parameters define at least one scaling function, and one or more y-coordinate values of the at least one scaling function are represented in the one or more compact representations as one or more differences from an offset.

11. In some embodiments, one or more non-transitory computer-readable media store instructions that, when executed by at least one processor, cause the at least one processor to perform steps comprising generating, based on one or more film grain parameters associated with video content, one or more compact representations of the one or more film grain parameters, and transmitting the one or more compact representations to a client application executing on a client device, wherein the client application adds film grain to the video content, for playback, based on the one or more compact representations.

12. The one or more non-transitory computer-readable media of clause 11, wherein the one or more film grain parameters define a plurality of scaling functions, and the one or more compact representations include one or more linear function coefficients for predicting at least one predicted scaling function based on a first scaling function included in the plurality of scaling functions.

13. The one or more non-transitory computer-readable media of clauses 11 or 12, wherein the one or more compact representation further include one or more residuals between the at least one predicted scaling function and at least one corresponding scaling function included in the plurality of scaling functions.

14. The one or more non-transitory computer-readable media of any of clauses 11-13, wherein the one or more film grain parameters include a set of x-coordinate values associated with a scaling function, and wherein the one or more compact representations include a set of increments associated with the set of x-coordinate values.

15. The one or more non-transitory computer-readable media of any of clauses 11-14, wherein, in the one or more compact representations, at least one of (i) the set of increments is represented as a set of differences from an offset, or (ii) a first increment included in the set of increments is represented using fewer bits than a second increment included in the set of increments.

16. The one or more non-transitory computer-readable media of any of clauses 11-15, wherein the one or more film grain parameters include a set of coefficients of an autoregressive model, and each coefficient included in the set of coefficients is represented in the one or more compact representations using a number of bits that is determined based on a range associated with the set of coefficients.

17. The one or more non-transitory computer-readable media of any of clauses 11-16, further comprising transmitting metadata to the client device specifying the one or more compact representations.

18. The one or more non-transitory computer-readable media of any of clauses 11-17, wherein the one or more compact representations include a variable-length encoding of at least one of the one or more film grain parameters.

19. The one or more non-transitory computer-readable media of any of clauses 11-18, wherein the one or more compact representations include at least one exp-Golomb code.

20. In some embodiments, a system comprises one or more memories storing instructions, and one or more processors that are coupled to the one or more memories and, when executing the instructions, are configured to generate, based on one or more film grain parameters associated with video content, one or more compact representations of the one or more film grain parameters, and transmit the one or more compact representations to a client application executing on a client device, wherein the client application adds film grain to the video content, for playback, based on the one or more compact representations.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for transmitting film grain parameters to one or more client devices for use when playing back video content, the method comprising:
generating, based on one or more film grain parameters associated with video content, one or more compact representations of the one or more film grain parameters; and
transmitting the one or more compact representations to a client application executing on a client device, wherein the client application adds film grain to the video content, for playback, based on the one or more compact representations.

2. The computer-implemented method of claim 1, wherein the one or more film grain parameters define a plurality of scaling functions, and the one or more compact representations include one or more linear function coefficients for predicting at least one predicted scaling function based on a first scaling function included in the plurality of scaling functions.

3. The computer-implemented method of claim 2, wherein the one or more compact representation further include one or more residuals between the at least one predicted scaling function and at least one corresponding scaling function included in the plurality of scaling functions.

4. The computer-implemented method of claim 2, wherein the one or more compact representation further include a lossy encoding of one or more residuals between the at least one predicted scaling function and at least one corresponding scaling function included in the plurality of scaling functions.

5. The computer-implemented method of claim 1, wherein the one or more film grain parameters include a set of x-coordinate values associated with a scaling function, and wherein the one or more compact representations include a set of increments associated with the set of x-coordinate values.

6. The computer-implemented method of claim 5, wherein the set of increments is represented as a set of differences from an offset.

7. The computer-implemented method of claim 5, wherein a first increment included in the set of increments is represented using fewer bits than a second increment included in the set of increments.

8. The computer-implemented method of claim 1, wherein the one or more film grain parameters include a set of coefficients of an autoregressive model, and each coefficient included in the set of coefficients is represented in the one or more compact representations using a number of bits that is determined based on a range associated with the set of coefficients.

9. The computer-implemented method of claim 1, further comprising transmitting metadata to the client device specifying the one or more compact representations.

10. The computer-implemented method of claim 1, wherein the one or more film grain parameters define at least one scaling function, and one or more y-coordinate values of the at least one scaling function are represented in the one or more compact representations as one or more differences from an offset.

11. One or more non-transitory computer-readable media storing instructions that, when executed by at least one processor, cause the at least one processor to perform steps comprising:
generating, based on one or more film grain parameters associated with video content, one or more compact representations of the one or more film grain parameters; and
transmitting the one or more compact representations to a client application executing on a client device, wherein the client application adds film grain to the video content, for playback, based on the one or more compact representations.

12. The one or more non-transitory computer-readable media of claim 11, wherein the one or more film grain parameters define a plurality of scaling functions, and the one or more compact representations include one or more linear function coefficients for predicting at least one predicted scaling function based on a first scaling function included in the plurality of scaling functions.

13. The one or more non-transitory computer-readable media of claim 12, wherein the one or more compact representation further include one or more residuals between the at least one predicted scaling function and at least one corresponding scaling function included in the plurality of scaling functions.

14. The one or more non-transitory computer-readable media of claim 11, wherein the one or more film grain parameters include a set of x-coordinate values associated with a scaling function, and wherein the one or more compact representations include a set of increments associated with the set of x-coordinate values.

15. The one or more non-transitory computer-readable media of claim 14, wherein, in the one or more compact representations, at least one of (i) the set of increments is represented as a set of differences from an offset, or (ii) a first increment included in the set of increments is represented using fewer bits than a second increment included in the set of increments.

16. The one or more non-transitory computer-readable media of claim 11, wherein the one or more film grain parameters include a set of coefficients of an autoregressive model, and each coefficient included in the set of coefficients is represented in the one or more compact representations using a number of bits that is determined based on a range associated with the set of coefficients.

17. The one or more non-transitory computer-readable media of claim 11, further comprising transmitting metadata to the client device specifying the one or more compact representations.

18. The one or more non-transitory computer-readable media of claim 11, wherein the one or more compact representations include a variable-length encoding of at least one of the one or more film grain parameters.

19. The one or more non-transitory computer-readable media of claim 11, wherein the one or more compact representations include at least one exp-Golomb code.

20. A system, comprising:
one or more memories storing instructions; and
one or more processors that are coupled to the one or more memories and, when executing the instructions, are configured to:
generate, based on one or more film grain parameters associated with video content, one or more compact representations of the one or more film grain parameters, and
transmit the one or more compact representations to a client application executing on a client device, wherein the client application adds film grain to the video content, for playback, based on the one or more compact representations.
